(19) United States
(12) Patent Application Publication
(10) Pub. No.: US 2024/0177043 A1
(43) Pub. Date: May 30, 2024

(54) Method for Determining Fidelity of Qubit Gate in Quantum Chip, and Storage Medium

(71) Applicant: Alibaba Damo (Hangzhou) Technology Co., Ltd., Hangzhou, Zhejiang (CN)

(72) Inventors: Xingyu CHEN, Hangzhou, Zhejiang (CN); Feng WU, Hangzhou, Zhejiang (CN); Xiaotong NI, Hangzhou, Zhejiang (CN); Huihai ZHAO, Beijing (CN); Mingpu QIN, Hangzhou, Zhejiang (CN)

(21) Appl. No.: 18/516,031

(22) Filed: Nov. 21, 2023

(30) Foreign Application Priority Data
Nov. 24, 2022 (CN) 202211482393.5

(51) Int. Cl. G06N 10/40

(52) U.S. Cl. CPC G06N 10/40

(57) ABSTRACT

This disclosure discloses a method for determining fidelity of a qubit gate in a quantum chip, and a storage medium. The method includes: determining environmental qubit gates associated with a two-qubit gate in the quantum chip, where the two-qubit gate interacts with the environmental qubit gates in the quantum chip; determining, based on the two-qubit gate and the environmental qubit gates, a first target matrix and a corresponding first evolution matrix, where the first target matrix is a diagonal matrix constructed based on a logic gate, and the first evolution matrix is a matrix obtained after time-dependent evolution; and determining the fidelity of the two-qubit gate based on the number of the environmental qubit gates associated with the two-qubit gate, the first target matrix, and the first evolution matrix. This disclosure solves the technical problem of being unable to determine the fidelity of the two-qubit gate.

### CROSS REFERENCE TO RELATED APPLICATIONS

The disclosure claims the benefits of priority to Chinese Application No. 202211482393.5, filed on Nov. 24, 2022, which is incorporated herein by reference in its entirety.

### TECHNICAL FIELD

This disclosure relates to the field of superconducting quantum, and in particular relates to a method for determining fidelity of a qubit gate in a quantum chip, and a storage medium.

### BACKGROUND

In the design process of quantum chips, only the fidelity of isolated two-qubit gates is considered. However, during the usage of the quantum chips, the two-qubit gates inevitably interact with quantum bits in the environment. But there is no existing technology available to characterize the fidelity of the two-qubit gates in a multi-bit environment currently, causing a technical problem of being unable to determine the fidelity of the two-qubit gate.

### SUMMARY

The disclosed embodiments provide a method for determining fidelity of a qubit gate in a quantum chip, and a storage medium, so as to at least solve the technical problem of being unable to determine the fidelity of the two-qubit gate.

According to some embodiments of this disclosure, a method is provided for determining fidelity of a qubit gate in a quantum processor. The method may include: determining environmental qubit gates associated with a two-qubit gate in the quantum chip, where the two-qubit gate interacts with the environmental qubit gates in the quantum chip; determining, based on the two-qubit gate and the environmental qubit gates, a first target matrix and a corresponding first evolution matrix, where the first target matrix is a diagonal matrix constructed based on a logic gate, and the first evolution matrix is a matrix obtained after time-dependent evolution; and determining the fidelity of the two-qubit gate based on the number of the environmental qubit gates, the first target matrix, and the first evolution matrix.

According to some embodiments of this disclosure, a method is provided for determining fidelity of a qubit gate in a quantum processor. The method may include: acquiring, by invoking a first interface, environmental qubit gates associated with a two-qubit gate in a quantum chip, where the first interface includes a first parameter, the parameter value of the first parameter involves the two-qubit gate and the environmental qubit gates, and the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and outputting, by invoking a second interface, the fidelity of the two-qubit gate, where the second interface includes a second parameter, and the parameter value of the second parameter represents the fidelity of the two-qubit gate.

According to some embodiments of this disclosure, a method is provided for determining fidelity of a qubit gate in a quantum processor. The method may include: acquiring, from a quantum platform, environmental qubit gates associated with a two-qubit gate in a quantum chip, where the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and returning the fidelity of the two-qubit gate to the quantum platform.

According to some embodiments of this disclosure, an apparatus is provided for determining fidelity of a qubit gate in a quantum processor. The apparatus may include: a memory storing instructions; and one or more processors configured to execute the instructions to cause the apparatus to perform operations including: determining environmental qubit gates associated with a two-qubit gate in the quantum chip, wherein the two-qubit gate interacts with the environmental qubit gates in the quantum chip; determining a first target matrix and a corresponding first evolution matrix, based on the two-qubit gate and the environmental qubit gates associated with the two-qubit gate, wherein the first target matrix is a diagonal matrix constructed based on a logic gate, and the first evolution matrix is a matrix obtained after time-dependent evolution; and determining the fidelity of the two-qubit gate based on the number of the environmental qubit gates, the first target matrix, and the first evolution matrix.

According to some embodiments of this disclosure, an apparatus is provided for determining fidelity of a qubit gate in a quantum processor. The apparatus may include: a memory storing instructions; and one or more processors configured to execute the instructions to cause the apparatus to perform operations including: acquiring, by invoking a first interface, environmental qubit gates associated with a two-qubit gate in the quantum chip, wherein the first interface includes a first parameter having a first parameter corresponding to the two-qubit gate and the environmental qubit gates, wherein the two-qubit gate interacts with the environmental qubit gates in the quantum chip; determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution; determining the fidelity of the two-qubit gate based on the number of the environmental qubit gates interacting with the two-qubit gate, the first target matrix, and the first evolution matrix; and outputting the fidelity of the two-qubit gate by invoking a second interface, wherein the second interface includes a second parameter having a second parameter value representing the fidelity of the two-qubit gate.

According to some embodiments of this disclosure, an apparatus is provided for determining fidelity of a qubit gate in a quantum processor. The apparatus may include: a memory storing instructions; and one or more processors configured to execute the instructions to cause the apparatus to perform operations including: acquiring, from a quantum platform, environmental qubit gates associated with a two-qubit gate in the quantum chip, wherein the two-qubit gate interacts with the environmental qubit gates in the quantum chip; determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution; determining the fidelity of the two-qubit gate based on the number of the environmental qubit gates associated with the two-qubit gage, the first target matrix, and the first evolution matrix; and returning the fidelity of the two-qubit gate to the quantum platform.

According to some embodiments of this disclosure, a computer-readable storage medium is provided and includes stored programs. The programs, when run, control a device where the storage medium is located to execute any above method for determining fidelity of a qubit gate in a quantum processor.

According to some embodiments of this disclosure, a processor is provided. The processor is configured to run programs. The programs, when run, execute any above method for determining fidelity of a qubit gate in a quantum processor.

It is easily noted that the above general description, as well as the following detailed description are merely for the purpose of illustrating and explaining this disclosure, but do not constitute limitation to this disclosure.

### BRIEF DESCRIPTION OF THE DRAWINGS

The accompanying drawings described here are used for providing a further understanding of this disclosure, and forming a part of this disclosure. Illustrative embodiments of this disclosure and descriptions thereof are used for explaining this disclosure, but do not constitute inappropriate limitation to this disclosure. In the accompanying drawings:

FIG. 1 is a block diagram of a hardware structure of an example computer terminal (or mobile device) for implementing a method for determining fidelity of a qubit gate in a quantum processor, according to some embodiments of this disclosure.

FIG. 2 is a structural block diagram of an example computing environment according to some embodiments of this disclosure.

FIG. 3 is a structural block diagram of an example service mesh according to some embodiments of this disclosure.

FIG. 4 is a flowchart of an example method for determining fidelity of a qubit gate in a quantum processor according to some embodiments of this disclosure.

FIG. 5 is a flowchart of an example method for determining fidelity of a qubit gate in a quantum processor according to some embodiments of this disclosure.

FIG. 6 is a schematic diagram illustrating an example computer device accessing a private network according to some embodiments of this disclosure.

FIG. 7 is a flowchart of an example method for determining fidelity of a qubit gate in a quantum processor according to some embodiments of this disclosure.

FIG. 8 is a schematic diagram of an example decomposition result according to some embodiments of this disclosure.

FIG. 9 is a schematic diagram of determining a fidelity error according to some embodiments of this disclosure.

FIG. 10 is a schematic diagram of determining time complexity for fidelity according to some embodiments of this disclosure.

FIG. 11 is a schematic diagram of an example apparatus for determining fidelity of a qubit gate in a quantum chip according to some embodiments of this disclosure.

FIG. 12 is a schematic diagram of an example apparatus for determining fidelity of a qubit gate in a quantum chip according to some embodiments of this disclosure.

FIG. 13 is a schematic diagram of an example apparatus for determining fidelity of a qubit gate in a quantum chip according to some embodiments of this disclosure.

FIG. 14 is a structural block diagram of an example computer terminal according to some embodiments of this disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

As stated above, there is no existing technology available to characterize the fidelity of the two-qubit gates in a multi-bit environment. Embodiments of the present disclosure overcome this issue.

For example, the quantum chip's environmental qubit gates linked to the two-qubit gate are acquired by invoking the first interface. This interface includes the first parameter, which entails the parameter value of the first parameter, involving the two-qubit gate and the environmental qubit gates. The two-qubit gate interacts with the environmental qubit gates within the quantum chip, and the first target matrix and the corresponding first evolution matrix are determined based on both the two-qubit gate and the environmental qubit gates. The first target matrix is the diagonal matrix represented based on the logic gate, and the first evolution matrix is the matrix obtained after time-dependent evolution. The fidelity of the two-qubit gate is determined based on the number of environmental qubit gates, the first target matrix, and the first evolution matrix. The fidelity of the two-qubit gate is outputted by invoking a second interface, which includes the second parameter, and the parameter value of the second parameter.

Put simply, this disclosure takes into account the effects on the two-qubit gate from environmental qubit gates in the quantum processor. By utilizing the first target matrix and first evolution matrix with the added environmental qubit gates, the accuracy of measuring the fidelity of the two-qubit gate in a multi-qubit environment is improved. This achieves the technical effect of determining the fidelity of the two-qubit gate, thereby solving the technical problem of being unable to determine its fidelity.

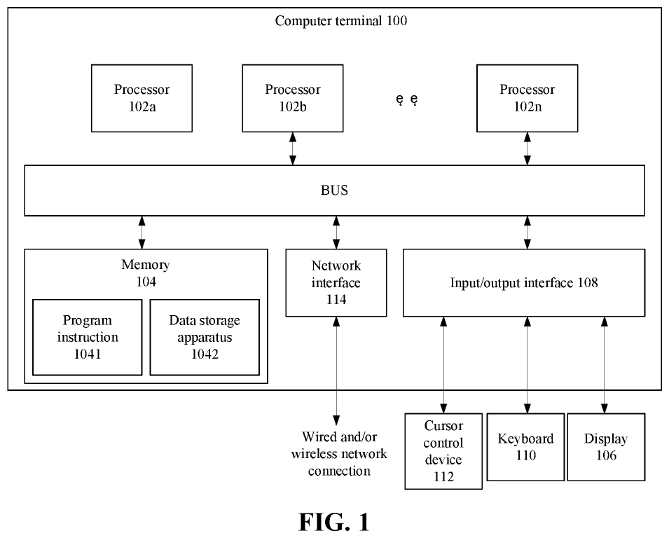

The example method provided by some embodiments of this disclosure may be implemented in a mobile terminal, a computer terminal or similar computing devices. FIG. 1 is a block diagram of a hardware structure of a computer terminal (or mobile device) for implementing an example method for determining fidelity of a qubit gate in a quantum processor according to some embodiments of this disclosure. It is to be noted that, steps shown in flowcharts of the drawings may be performed in a computer system with a set of computer executable instructions. In addition, although logical sequences are shown in the flowcharts, in some cases, the steps illustrated or described may be performed in a different order than presented here.

As shown in FIG. 1, computer terminal 100 (or mobile device) may include one or more processors (shown in the figure as 102a, 102b . . . 102n, and the processors may include but be not limited to processing apparatuses such as a microprocessor MCU or a programmable logic device FPGA), a memory 104 configured to store data, and a transmission apparatus configured to perform a communication function. In addition, computer terminal 100 may further include a display 106, an input/output interface (I/O interface) 108, a keyboard 110, a cursor control device 112, a universal serial bus (USB) port (which may be included as one of the ports of a BUS), a network interface 114, a power supply or a camera. It is appreciated that the structure shown in FIG. 1 is only a schematic diagram and does not cause limitation to the structure of the electronic apparatus. For example, the computer terminal 100 may further include more or less components than those shown in FIG. 1, or has different configurations from those shown in FIG. 1.

It is be noted that the one or more processors or other data processing circuits may be generally called as a “data processing circuit” in this text. The data processing circuit may be completely or partially embodied as software, hardware, firmware or any other combination. In addition, the data processing circuit may be a single independent processing module or be completely or partially combined into any one of other elements in the computer terminal 100 (or mobile device). As involved in the embodiments of the present disclosure, the data processing circuit serves as a processor control (such as selection of a variable resistance terminal path connected with the interface).

Memory 104 can be configured to store software programs of application software and modules, such as a program instruction 1041/data storage apparatus 1042 corresponding to the qubit processing method according to the embodiments of the present disclosure; and the processor executes various function applications and data processing by running the software programs and the modules stored in memory 104, namely, a qubit processing method for the application programs is realized. Memory 104 can include a high-speed random access memory and can also include a nonvolatile memory, such as one or more magnetic storage apparatuses, flash memories or other nonvolatile solid-state memories. In the disclosed embodiments, memory 104 can further include memories remotely arranged relative to the processor, and the remote memories may be connected to computer terminal 100 through a network. The examples of the network include but are not limited to the Internet, an intranet, a local area network, a mobile communication network and a combination thereof.

The transmission apparatus is configured to receive or transmit data through a network. The specific examples of the network can include a wireless network provided by a communication provider of computer terminal 100. In the disclosed embodiments, the transmission apparatus includes a network interface controller (NIC), and the network interface controller can be connected with other network devices through a base station so as to communicate with the internet. In one example, the transmission apparatus may be a radio frequency (RF) module and is configured to communicate with the internet in a wireless mode.

Display 106 may be a touch screen type liquid crystal display (LCD) for example, and the liquid crystal display enables a user to interact with a user interface of computer terminal 100 (or mobile device).

It is to be noted that in some alternative embodiments, the computer device (or mobile device) shown in FIG. 1 may include a hardware element (including a circuit), a software element (including computer codes stored on the computer readable medium) or a combination of the hardware element and the software element.

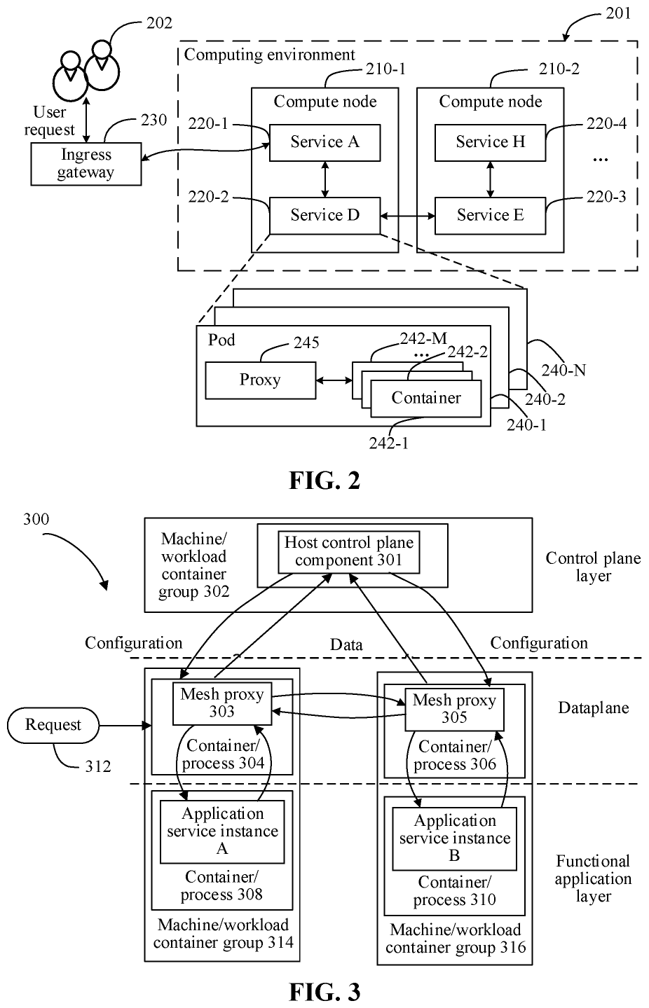

The block diagram of the hardware structure shown in FIG. 1 may not only serve as an illustrative block diagram for the above computer terminal 100 (or mobile device) but also serve as an illustrative block diagram for the above server. In some embodiments, FIG. 2 illustrates, in a block diagram form, an example of using the computer terminal 100 (or mobile device) shown in the above FIG. 1 as a compute node in a computing environment 201. FIG. 2 is a structural block diagram of a computing environment according to some embodiments of this disclosure. As shown in FIG. 2, the computing environment 201 includes a plurality of compute nodes (such as the server) (illustrated by 210-1, 210-2 . . . in the figure) running on a distributed network. Each compute node includes local processing and memory resources, allowing end users 202 to remotely run applications or store data in the computing environment 201. The applications may be provided as a plurality of services 220-1, 220-2, 220-3, and 220-4 in the computing environment 201, representing services “A”, “D”, “E” and “H” respectively.

The end users 202 may provide and access services through a web browser or other software applications on a client side. In the disclosed embodiments, the provisioning or requests of the end users 202 may be routed to an ingress gateway 230. The ingress gateway 230 may include a corresponding proxy to handle the provisioning or requests for services (one or more services provided in the computing environment 201).

The services are provided or deployed based on various virtualization technologies supported by the computing environment 201. In the disclosed embodiments, the services can be provided according to virtual machine (VM)-based virtualization, container-based virtualization, or similar approaches. The virtual machine-based virtualization may involve simulating real computers by initializing the virtual machine, allowing programs and applications to be run without direct access to any physical hardware resources. While virtualizing machines, according to the container-based virtualization, the virtual machine allows the virtualization of an entire operating systems (OS) by launching containers, which enables a plurality of workloads to be run on a single example of the operating system.

In some embodiments of the container-based virtualization, several containers of the service may be assembled into a Pod (e.g., Kubernetes Pod). For example, as shown in FIG. 2, the service 220-2 may be equipped with one or more Pods 240-1, 240-2, . . . , and 240-N (collectively referred to as Pods). Each Pod may include a proxy 245 and one or more containers 242-1, 242-2, . . . , and 242-M (collectively referred to as containers). One or more containers within the Pod handle requests related to one or more corresponding functions of the service. The proxy 245 typically controls network functions associated with the service, such as routing and load balancing. Other services may also be equipped with Pods similar to the mentioned Pod.

In the operation process, executing user requests from the end users 202 may require invoking one or more services in the computing environment 201. Performing one or more functions of a service may require invoking one or more functions of another service. As shown in FIG. 2, the service “A” 220-1 receives the user requests from the end users 202 via the ingress gateway 230. The service “A” 220-1 can invoke the service “D” 220-2, and the service “D” 220-2 can request the service “E” 220-3 to perform one or more functions.

The above computing environment may be a cloud computing environment, and resource allocation is managed by cloud service providers, which allows for the development of functions without considering server implementation, adjustment, or extension. The computing environment allows developers to execute code in response to events without building or maintaining complex infrastructure. The services may be divided into a set of functions that can scale automatically and independently, rather than extending a single hardware device to handle potential loads.

In some embodiments, FIG. 3 illustrates, in a block diagram, an example of using the computer terminal 100 (or mobile device) shown in the above FIG. 1 as a service mesh. FIG. 3 is a structural block diagram of a service mesh according to some embodiments of this disclosure. As shown in FIG. 3, the service mesh 300 is mainly configured to facilitate secure and reliable communication between a plurality of microservices. The microservices refer to breaking down an application into smaller services or examples that are distributed on different clusters/machines to be run.

As shown in FIG. 3, the microservices may include an application service instance A and an application service instance B, which form a functional application layer of the service mesh 300. According to some embodiments, the application service instance A is run in the form of a container/process 308 within a machine/workload container group 314 (Pod). The application service instance B is run in the form of a container/process 310 within a machine/workload container group 316 (Pod).

According to some embodiments, the application service instance A may be a commodity query service. The application service instance B may be a commodity ordering service.

As shown in FIG. 3, the application service instance A and a mesh proxy (sidecar) 303 coexist within the machine/workload container group 614. The application service instance B and a mesh proxy 305 coexist within the machine/workload container group 314. The mesh proxy 303 and the mesh proxy 305 form a dataplane of the service mesh 300. The mesh proxy 303 and the mesh proxy 305 are run as the container/process 304 and the container/process 306 respectively, and can receive a request 312 for performing the commodity query service. The mesh proxy 303 and the application service instance A can be in bidirectional communication, and the mesh proxy 305 and the application service instance B can also be in bidirectional communication. In addition, the mesh proxy 303 and the mesh proxy 305 may be in bidirectional communication.

According to some embodiments, all traffic from the application service instance A is routed to an appropriate destination through the mesh proxy 303. All network traffic from the application service instance B is routed to an appropriate destination through the mesh proxy 305. It is to be noted that, the network traffic mentioned here includes, but is not limited to, forms such as a hypertext transfer protocol (HTTP) and a representational state transfer (REST), characterized by high performance.

According to some embodiments, the function of expanding the dataplane is realized by writing a custom filter for the proxy (Envoy) in the service mesh 300. The configuration of service mesh proxy is to ensure correct proxying of service traffic by the service mesh, and achieve service communication and governance. The mesh proxy 303 and the mesh proxy 305 may be configured to perform at least one of the following functions: service discovery, health checking, routing, load balancing, authentication and authorization, and observability.

As shown in FIG. 3, the service mesh 300 may further include a control plane layer. The control plane layer may comprise a set of services run in a dedicated namespace, which are hosted by a host control plane component 301 within the machine/workload container group (machine/Pod) 302. As shown in FIG. 3, the host control plane component 301 is in bidirectional communication with the mesh proxy 303 and the mesh proxy 305. The host control plane component 301 is configured to perform some control and management functions. For example, the host control plane component 301 receives telemetry data transmitted by the mesh proxy 303 and the mesh proxy 305, and can further aggregate the telemetry data. Due to the services, the host control plane component 301 can also provide a user-facing application programming interface (abbreviated as API), thereby facilitating easy manipulation of network behaviors and supplying configuration data to the mesh proxy 303 and the mesh proxy 305, etc.

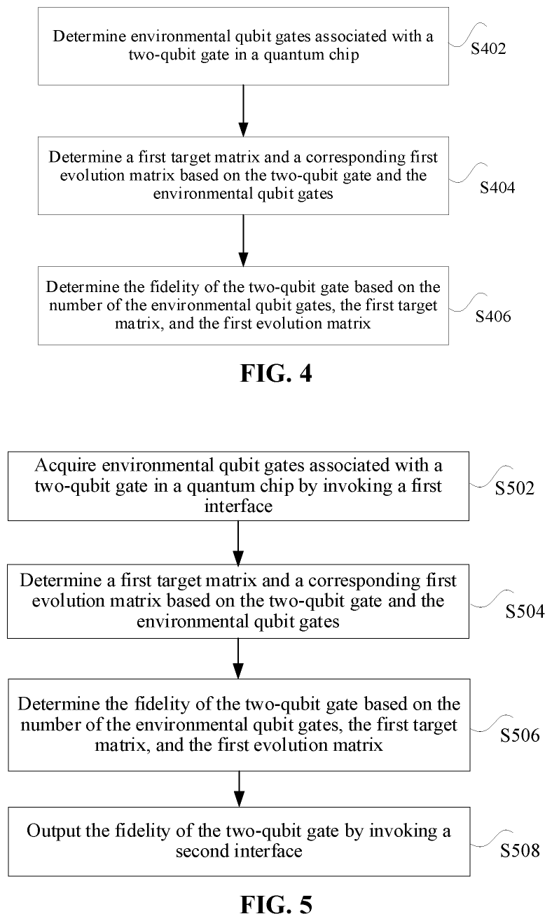

FIG. 4 is a flowchart of an example method for determining fidelity of a qubit gate in a quantum processor according to some embodiments of this disclosure. As shown in FIG. 4, the method may include the following steps S402-S406.

Step S402: Determining environmental qubit gates associated with a two-qubit gate in the quantum processor, where the two-qubit gate interacts with the environmental qubit gates in the quantum processor.

In step S402, the environmental qubit gates associated with the two-qubit gate in the quantum processor can be determined, where the two-qubit gate interacts with the environmental qubit gates in the quantum processor. The environmental qubit gate may comprise environmental quantum bits (abbreviated as environmental qubits) surrounding the two-qubit gate, which may be a quantum gate for one environmental bit or for two or more environmental bits. The environmental qubit gate is not specifically limited here. The quantum processor may include a quantum system.

In some embodiments, in the quantum processor, the control effect of the two-qubit gate can be influenced by the surrounding quantum bits. The quantum bits influencing the two-qubit gate around the two-qubit gate can be determined, thereby determining the environmental qubit gates associated with the two-qubit gate in the quantum processor.

Step S404: Determining a first target matrix and a corresponding first evolution matrix based on the two-qubit gate and the environmental qubit gates, where the first target matrix is a diagonal matrix constructed based on a logic gate, and the first evolution matrix is a matrix obtained after time-dependent evolution.

In step S404, the first target matrix and the first evolution matrix corresponding to the first target matrix can be determined based on the two-qubit gate and the environmental qubit gates. The first target matrix (Uₜ) may be the diagonal matrix constructed based on the logic gate. The first evolution matrix (Uᵣ) may be the matrix obtained after time evolution (time-dependent evolution).

In some embodiments, taking into account the influence of environmental bits on the two-qubit gate, the first target matrix can be determined based on the two-qubit gate and the environmental qubit gates. For example, by adding two environmental qubit gates to the two-qubit gate, the first target matrix can be obtained. Considering that the influence of the environmental qubit gates on the two-qubit gate varies over time, after time-delayed evolution is performed on the two-qubit gate, processing is performed based on the environmental qubit gates and a matrix obtained after time-delayed evolution, and the first evolution matrix can be obtained.

Step S406: Determining the fidelity of the two-qubit gate based on the number of the environmental qubit gates, the first target matrix, and the first evolution matrix.

In step S406, the fidelity (Fave) of the two-qubit gate can be determined based on the number of the environmental qubit gates, the first target matrix, and the first evolution matrix.

In the conventional technologies, during computing of the fidelity of the qubit gates, only the fidelity of the isolated two-qubit gate can be computed. However, in a real quantum chip, the two-qubit gate inevitably interacts with the surrounding quantum bits. In consideration of this case in an example of this disclosure, the first target matrix and the first evolution matrix are determined based on the environmental qubit gates associated with the two-qubit gate. Because the two-qubit gate is associated with at least one environmental qubit gate, the number of the environmental qubit gates, the first target matrix, and the first evolution matrix are taken into account in an example of this disclosure for determining the fidelity of the two-qubit gate, thereby solving the technical problem of inaccurately determining the fidelity of the two-qubit gate in the prior art, and achieving the technical effect of accurately determining the fidelity of the two-qubit gate.

According to the above steps S402 to S408 of this disclosure, the environmental qubit gates associated with the two-qubit gate in the quantum chip are obtained by invoking a first interface. The first interface includes a first parameter, the parameter value of the first parameter involves the two-qubit gate and the environmental qubit gates, and the two-qubit gate interacts with the environmental qubit gates in the quantum chip. The first target matrix and the corresponding first evolution matrix are determined based on the two-qubit gate and the environmental qubit gates, where the first target matrix is the diagonal matrix represented based on the logic gate, and the first evolution matrix is the matrix obtained after time-dependent evolution. The fidelity of the two-qubit gate is determined based on the number of the environmental qubit gates, the first target matrix, and the first evolution matrix. The fidelity of the two-qubit gate is outputted by invoking a second interface, where the second interface includes a second parameter, and the parameter value of the second parameter represents the fidelity of the two-qubit gate. In other words, in an example of this disclosure, the influence on the two-qubit gate from the environmental qubit gates associated with the two-qubit gate in the quantum processor is considered. Based on the first target matrix and the first evolution matrix obtained after adding the environmental qubit gates, the fidelity of the two-qubit gate in a multi-qubit environment is determined, thereby improving the accuracy of measuring the fidelity of the two-qubit gate, achieving the technical effect of determining the fidelity of the two-qubit gate, and solving the technical problem of being unable to determine the fidelity of the two-qubit gate.

For example, in the case that the two-qubit gate does not interact with the environmental qubit gates, the fidelity of the two-qubit gate is determined by a second target matrix and a second evolution matrix. The second target matrix is used for representing the logic gate, and the second evolution matrix comprises a plurality of block matrices undergoing time-dependent evolution. Determining, based on the two-qubit gate and the environmental qubit gates, a first target matrix and a corresponding first evolution matrix includes that: adjusting the second target matrix based on the environmental qubit gates to obtain the first target matrix; and adjusting the second evolution matrix based on the environmental qubit gates to obtain the first evolution matrix.

In the disclosed embodiments, in the case that the two-qubit gate does not interact with the environmental qubit gates, the fidelity of the two-qubit gate can be determined based on the second target matrix and the second evolution matrix. The second target matrix (U_{target}) can be used for representing the logic gate, and the second evolution matrix (U₀) may be composed of a plurality of block matrices undergoing time-dependent evolution (e.g., U₀¹¹ U₀¹² U₀¹³ U₀¹⁴).

In some embodiments, the second evolution matrix can be determined based on the following formula:

$${U}_{0} = ( \begin{matrix}{U}_{0}^{11} & {U}_{0}^{12} & {U}_{0}^{13} & {U}_{0}^{14} \\ {U}_{0}^{21} & {U}_{0}^{22} & {U}_{0}^{23} & {U}_{0}^{24} \\ {U}_{0}^{31} & {U}_{0}^{32} & {U}_{0}^{33} & {U}_{0}^{34} \\ {U}_{0}^{41} & {U}_{0}^{42} & {U}_{0}^{43} & {U}_{0}^{44}\end{matrix} )$$

In some embodiments, the fidelity of the two-qubit gate can be obtained based on the following formula:

$${F}_{ave} ( U , {U}_{target} ) = \frac{Tr ( {U}^{†} U ) + {\vert Tr ( {U}_{target}^{†} U ) \vert}^{2}}{20}$$

where, Fave (U, U_{target}) can be used for representing the fidelity of the two-qubit gate determined based on the second target matrix and the second evolution matrix; Tr can be used for representing the trace operation, and U⁺ can be used for representing a conjugate transpose matrix of the second evolution matrix; and U_{target}⁺ can be used for representing the conjugate transpose of the second target matrix.

For example, considering the influence of environmental qubit gates on the two-qubit gate, the second target matrix can be adjusted based on the environmental qubit gates to obtain the first target matrix, and the second evolution matrix can be adjusted based on the environmental qubit gates to obtain the first evolution matrix.

According to some embodiments, adjusting the second target matrix based on the environmental qubit gates to obtain the first target matrix includes that: performing tensor processing on the second target matrix based on the environmental qubit gates to obtain the first target matrix.

For example, the first target matrix can be obtained by performing the tensor processing on the second target matrix based on the environmental qubit gates. Taking the two-qubit gate (iswap gate) as an example, the first target matrix can be used for representing the matrix obtained when the two-qubit gate is not affected by the surrounding environmental qubit gates. The first target matrix can be determined based on the following formula:

$${U}_{t} = ( \begin{matrix}1 & 0 \\ 0 & {e}^{i {θ}_{1}}\end{matrix} ) ⊗ ( \begin{matrix}1 & 0 \\ 0 & {e}^{i {θ}_{2}}\end{matrix} ) ⊗ i Swap = ( \begin{matrix}i Swap & 0 & 0 & 0 \\ 0 & {e}^{i {θ}_{2}} i Swap & 0 & 0 \\ 0 & 0 & {e}^{i {θ}_{1}} i Swap & 0 \\ 0 & 0 & 0 & {e}^{i {θ}_{1} + i {θ}_{2}} i Swap\end{matrix} )$$

where, iSwap can be used for representing a logic gate, and characterizing interchanging of the states of two qubits in the two-qubit gate; i is an imaginary unit; and

$$( \begin{matrix}1 & 0 \\ 0 & {e}^{i {θ}_{1}}\end{matrix} ) and ( \begin{matrix}1 & 0 \\ 0 & {e}^{i {θ}_{2}}\end{matrix} )$$

may be evolution matrices obtained when the environmental qubit gates undergo isolated evolution.

According to some embodiments, adjusting the second evolution matrix based on the environmental qubit gates to obtain the first evolution matrix includes that: rotating the second evolution matrix based on the environmental qubit gates to obtain the first evolution matrix.

In the disclosed embodiments, due to the inevitable interaction between the two-qubit gate and the surrounding environmental quantum bits, the second evolution matrix can be rotated based on the environmental qubit gates to obtain the first evolution matrix.

In some embodiments, taking adding two single quantum bits as an example, the first evolution matrix can be determined based on the following formula:

$${U}_{r} = {R}_{4}^{l} ( {θ}_{1} , {θ}_{2} ) {U}_{0} {R}_{4}^{r} ( {θ}_{3} , {θ}_{4} ) = ( \begin{matrix}{U}_{r}^{11} & {U}_{r}^{12} & {U}_{r}^{13} & {U}_{r}^{14} \\ {U}_{r}^{21} & {U}_{r}^{22} & {U}_{r}^{23} & {U}_{r}^{24} \\ {U}_{r}^{31} & {U}_{r}^{32} & {U}_{r}^{33} & {U}_{r}^{34} \\ {U}_{r}^{41} & {U}_{r}^{42} & {U}_{r}^{43} & {U}_{r}^{44}\end{matrix} )$$

where, R₄^{l}(θ₁, θ₂) can be used for representing a single-bit evolution matrix assuming that the environmental bits remain unchanged before time evolution of a real system; R₄^{r}(θ₃, θ₄) can be used for representing a single-bit evolution matrix assuming that the environmental bits remain unchanged after time evolution of the real system; and θ₃ and θ₄ may be any preset unrelated independent parameters.

In some embodiments, R₄^{l}(θ₁, θ₂) and R₄^{r}(θ₃, θ₄) can be determined based on the following formula:

$$\begin{matrix}{R}_{4}^{l} ( {θ}_{1} , {θ}_{2} ) = I ⊗ I ⊗ {R}^{l} ( {θ}_{1} , {θ}_{2} ) = ( \begin{matrix}{R}^{l} & 0 & 0 & 0 \\ 0 & {R}^{l} & 0 & 0 \\ 0 & 0 & {R}^{l} & 0 \\ 0 & 0 & 0 & {R}^{l}\end{matrix} ) \\ {R}_{4}^{r} ( {θ}_{3} , {θ}_{4} ) = I ⊗ I ⊗ {R}^{r} ( {θ}_{3} , {θ}_{4} ) = ( \begin{matrix}{R}^{r} & 0 & 0 & 0 \\ 0 & {R}^{r} & 0 & 0 \\ 0 & 0 & {R}^{r} & 0 \\ 0 & 0 & 0 & {R}^{r}\end{matrix} )\end{matrix}$$

where, R^{l}(θ₁, θ₂) can be used for characterizing a single-qubit evolution matrix assuming that the environmental bits remain unchanged before time evolution of the real system; R^{r}(θ₃, θ₄) can be used for characterizing a single-bit evolution matrix assuming that the environmental bits remain unchanged after time evolution of the real system; R^{l} can be used for characterizing a single-bit evolution matrix without considering the environmental bits before time evolution of the real system; R^{r} can be used for characterizing a single-bit evolution matrix without considering the environmental bits before time evolution of the real system; and θ₁ and θ₂ may be any preset unrelated independent parameters.

According to some embodiments, determining the fidelity of the two-qubit gate based on the number of the environmental qubit gates, the first target matrix, and the first evolution matrix includes that: obtaining a first trace of a product between a conjugate transpose matrix of the first evolution matrix and the first evolution matrix; obtaining a second trace of a product between a conjugate transpose matrix of the first target matrix and the first evolution matrix; and determining the fidelity of the two-qubit gate based on the first trace and the square of the second trace, as well as the number of the environmental qubit gates.

For example, the first trace (Tr(Uᵣ^{†}Uᵣ)of the product between the conjugate transpose matrix of the first evolution matrix and the first evolution matrix can be obtained, the second trace (Tr(Uₜ^{†}Uᵣ)) of the product between the conjugate transpose matrix of the first target matrix and the first evolution matrix can be obtained, and the fidelity of the two-qubit gate can be determined based on the first trace and the square of the second trace, as well as the number of the environmental qubit gates.

According to some embodiments, the method includes determining the fidelity of the two-qubit gate based on the first trace and the square of the second trace, as well as the number of environmental qubit gates, which includes that: determining the fidelity of the two-qubit gate based on the first trace and the square of the second trace, the number of the environmental qubit gates, and an adjacent integer of the number of the environmental qubit gates.

In the disclosed embodiments, the fidelity of the two-qubit gate can be determined based on the first trace and the square of the second trace, the number of the environmental qubit gates, and the adjacent integer of the number of the environmental qubit gates.

In some embodiments, the fidelity of the two-qubit gate can be determined based on the following formula:

$${F}_{ave} ( {U}_{r} , {U}_{t} ) = \frac{Tr ( {U}_{r}^{†} {U}_{r} ) + {\vert Tr ( {U}_{t}^{†} {U}_{r} ) \vert}^{2}}{n ( n + 1 )}$$

where, Fave (Uᵣ, Uₜ) can be used for representing the fidelity of the two-qubit gate determined based on the first target matrix and the first evolution matrix; Tr can be used for representing the trace operation, and Uᵣ⁺ can be used for representing conjugate transpose of the first evolution matrix; Uₜ⁺ can be used for representing conjugate transpose of the first target matrix; n may represent the number of the environmental qubit gates and can be used for characterizing the dimensionality of the first target matrix, and in the case of having two qubit gates and two environmental qubits, n may be 16; and n+1 may represent an adjacent integer of the number of the environmental qubit gates.

According to some embodiments, the method includes that: in the case that the two-qubit gate does not interact with the environmental qubit gates, the fidelity of the two-qubit gate is at least determined by the second evolution matrix. Obtaining a first trace of a product between a conjugate transpose matrix of the first evolution matrix and the first evolution matrix includes that: a third trace of a product between the conjugate transpose matrix of the second evolution matrix and the second evolution matrix is determined as the first trace.

In the disclosed embodiments, in the case that the two-qubit gate does not interact with the environmental qubit gates, the fidelity of the two-qubit gate is at least determined by the second evolution matrix. The third trace of the product between the conjugate transpose matrix of the second evolution matrix and the second evolution matrix may be determined as the first trace, thereby achieving the purpose of determining the first trace.

In some embodiments, due to Tr(AB)=Tr(BA), TR(Uᵣ^{†}Uᵣ)=Tr(U₀^{†}U₀), and accordingly, the third trace of the product between the conjugate transpose matrix of the second evolution matrix and the second evolution matrix may be determined as the first trace.

According to some embodiments, the method includes that: obtaining a second trace of a product between a conjugate transpose matrix of the first target matrix and the first evolution matrix, which includes determining the second trace based on the sum of block matrices on a diagonal line of the second evolution matrix.

In the disclosed embodiments, the second trace may be determined based on the sum of the block matrices on the diagonal line of the second evolution matrix.

In some embodiments, when there are only 4 environmental quantum bits, the second trace can be determined based on the following formula:

$$\begin{matrix}Tr ( {U}_{r}^{†} {U}_{r} ) = Tr ( \begin{matrix}i {Swap}^{†} {U}_{r}^{11} & i {Swap}^{†} {U}_{r}^{12} & i {Swap}^{†} {U}_{r}^{13} & i {Swap}^{†} {U}_{r}^{14} \\ {e}^{- i {θ}_{2}} i {Swap}^{†} {U}_{r}^{21} & {e}^{- i {θ}_{2}} i {Swap}^{†} {U}_{r}^{22} & {e}^{- i {θ}_{2}} i {Swap}^{†} {U}_{r}^{23} & {e}^{- i {θ}_{2}} i {Swap}^{†} {U}_{r}^{24} \\ {e}^{- i {θ}_{1}} i {Swap}^{†} {U}_{r}^{31} & {e}^{- i {θ}_{1}} i {Swap}^{†} {U}_{r}^{32} & {e}^{- i {θ}_{1}} i {Swap}^{†} {U}_{r}^{33} & {e}^{- i {θ}_{1}} i {Swap}^{†} {U}_{r}^{34} \\ {e}^{- i {θ}_{1} - i {θ}_{2}} i {Swap}^{†} {U}_{r}^{41} & {e}^{- i {θ}_{1} - i {θ}_{2}} i {Swap}^{†} {U}_{r}^{42} & {e}^{- i {θ}_{1} - i {θ}_{2}} i {Swap}^{†} {U}_{r}^{43} & {e}^{- i {θ}_{1} - i {θ}_{2}} i {Swap}^{†} {U}_{r}^{44}\end{matrix} ) \\ = Tr ( i {Swap}^{†} ( {U}_{r}^{11} + {e}^{- i {θ}_{2}} {U}_{r}^{22} + {e}^{- i {θ}_{1}} {U}_{r}^{33} + {e}^{- i {θ}_{1} - i {θ}_{2}} {U}_{r}^{41} ) )\end{matrix}$$

Due to the following:

$$\begin{matrix}{R}_{4}^{l} ( {θ}_{1} , {θ}_{2} ) = I ⊗ I ⊗ {R}^{l} ( {θ}_{1} , {θ}_{2} ) = ( \begin{matrix}{R}^{l} & 0 & 0 & 0 \\ 0 & {R}^{l} & 0 & 0 \\ 0 & 0 & {R}^{l} & 0 \\ 0 & 0 & 0 & {R}^{l}\end{matrix} ) \\ {R}_{4}^{r} ( {θ}_{3} , {θ}_{4} ) = I ⊗ I ⊗ {R}^{r} ( {θ}_{3} , {θ}_{4} ) = ( \begin{matrix}{R}^{r} & 0 & 0 & 0 \\ 0 & {R}^{r} & 0 & 0 \\ 0 & 0 & {R}^{r} & 0 \\ 0 & 0 & 0 & {R}^{r}\end{matrix} )\end{matrix} ,$$

it can be determined that:

Tr(iSwap^{†}(Uᵣ¹¹+e^{-iθ}^{₂}Uᵣ²²+e^{-iθ}^{₁}Uᵣ³³+e^{-iθ}^{₂}^{-iθ}^{₂}Uᵣ⁴⁴))=Tr(iSwap^{†}R^{l}(U₀¹¹+e^{-iθ}^{₂}U₀²²+e^{-iθ}^{₁}U₀³³+e^{-iθ}^{₁}^{-iθ}^{₂}U₀⁴⁴)R^{r})

In an example of this disclosure, when there are only 4 environmental quantum bits, the problem of 4 quantum bits can be transformed into the problem of 2 quantum bits by simply multiplying four 4×4 block matrices on the diagonal line of the second evolution matrix by an environmental phase and then performing simple adding. The θ value corresponding to the highest fidelity can be found through variable θ₁, θ₂, θ₃, and θ₄. This method can be easily generalized to cases with any number of environmental bits.

According to some embodiments, the method further includes that: determining an initial time for evolution and an evolution duration of the quantum chip; dividing the evolution duration is into a plurality of equal sub-evolution durations; and determining the time-dependent Hamiltonian corresponding to each sub-evolution duration of the quantum chip based on the first evolution matrix, the initial time, and each sub-evolution duration.

For example, the initial time for evolution and the evolution duration of the quantum chip can be determined, the evolution duration can be divided into the plurality of equal sub-evolution durations, and based on the first evolution matrix, the initial time, and each sub-evolution duration, the time-dependent Hamiltonian corresponding to each sub-evolution duration of the quantum chip can be determined. The initial time (t₀0) may be the very beginning time of the evolution of the quantum chip; and the evolution duration (t) may be the evolution time of an electronic chip.

In some embodiments, the time at which the quantum chip is in an initial state and the time at which the quantum chip is in a final state can be determined. The initial time at which the quantum chip begins evolution and the evolution duration are obtained. The evolution time may be equally divided into smaller segments, thereby obtaining a plurality of equal sub-evolution durations. Based on the first evolution matrix, the initial time, and each sub-evolution duration, the time-dependent Hamiltonian (U(t₀+τ, t₀)) corresponding to each sub-evolution duration of the quantum chip can be determined.

In some embodiments, in a real superconducting quantum computing chip, a gate operation is implemented through the time evolution of a corresponding superconducting quantum system. In an example of this disclosure, high-efficiency simulation of the time evolution process of the superconducting quantum system is achieved by accurately determining the time-dependent Hamiltonian.

In some embodiments, the plurality of sub-evolution durations obtained by dividing the evolution duration/may satisfy following conditions:

U(t₁, t₀)=U(t₁, t₁−τ) . . . U(t₀+2τ, t₀+τ)U(t₀+τ, t₀)

where, τ can be used for representing a time interval.

In some embodiments, when τ<<1 is satisfied, the approximate value of the time-dependent Hamiltonian can be determined based on the following formula:

$$U ( {t}_{0} + τ , {t}_{0} ) = exp ( - i τ H ( {t}_{0} + \frac{τ}{2} ) )$$

where, exp is used for representing an exponential function; and H( ) can be used for representing a Hamiltonian function.

In the conventional technologies, the time evolution of a plurality of quantum bits is challenging due to the influence of the environmental bits. However, the influence of the environmental bits is taken into account in an example of this disclosure. The environmental qubit gates associated with the two-qubit gate in the quantum chip are determined, and the time-dependent Hamiltonian corresponding to each sub-evolution duration of the quantum chip is determined, thereby achieving the technical effect of accurately determining the fidelity of the two-qubit gate, and solving the technical problem of inaccurately determining the fidelity of the two-qubit gate.

According to some embodiments, the final state of the quantum chip after evolving from the initial state for an evolution duration is determined at least based on the time-dependent Hamiltonian corresponding to each sub-evolution duration of the quantum chip, each sub-evolution duration, and the number of sub-evolution durations.

For example, the final state of the quantum chip after evolving from the initial state for an evolution duration can be determined at least based on the time-dependent Hamiltonian corresponding to each sub-evolution duration of the quantum chip, each sub-evolution duration, and the number of sub-evolution durations. The sub-evolution duration can be used for characterizing a time interval; and the number of sub-evolution durations can be used for ensuring the number of the time intervals, which can be obtained as the ratio of the total duration to the time interval.

In some embodiments, a deterministic compiler (Trotter-Suzuki) can be used for decomposing the computation of time evolution, which can process parameters such as the time-dependent Hamiltonian, each sub-evolution duration, the number of sub-evolution durations, the initial state (|ψ₀ [symbol] ) of the two-qubit gate, and the order of the compiler, thereby obtaining the final state (|ψ(t) [symbol] ) of the quantum chip after evolving from the initial state for the evolution duration.

In some embodiments, because any Hamiltonian (H) can be written as a sum

$$( H = {\sum }_{ij} {h}_{ij} )$$

of a series of interactions between two-qubit gates, the deterministic compiler (Trotter-Suzuki) can perform decomposition based on the following formula to obtain the time-dependent Hamiltonian:

$$U ( {t}_{0} + τ , {t}_{0} ) = exp ( - i τ H ( {t}_{0} + \frac{τ}{2} ) ) \approx {\prod }_{ij} exp ( - i τ {h}_{ij} ( {t}_{0} + \frac{τ}{2} ) )$$

In some embodiments, the final state of the quantum chip after evolving from the initial state for the evolution duration can be determined based on a following formula:

|ψ(t) [symbol] =U(t,0)|ψ₀

[symbol]

where, U(t,0) can be used for characterizing the time-dependent Hamiltonian corresponding to a sub-evolution duration t.

According to some embodiments, the quantum chip is a superconducting quantum chip.

According to some embodiments, the superconducting quantum chip includes fluxonium-type qubits, or transmon-type qubits.

In this disclosure, fluxonium, also referred to as a flux qubit in the realm of superconducting quantum bits, serves as a primary quantum bit in magnetic flux quantum bits. It has the unique ability to connect numerous large junctions (acting as large capacitors) in series, followed by connecting these series of large junctions in parallel with small junctions. Interestingly, the entire loop lacks any small superconducting islands to prevent any influence from charge drift. The series connection of large junctions also provides a sufficiently large inductance, ensuring that quantum fluctuations in charge distribution are smaller than a Cooper pair charge. Moreover, when the system oscillation frequency is significantly lower than the plasma oscillation frequency of the large junctions, fluxonium can effectively suppress low-frequency charge drift, while preserving high-frequency oscillation components of the charge. Furthermore, when the magnetic flux in a fluxonium loop changes, the energy level structure can be tuned over a wide range, from 0.5 GHz to 10 GHz.

In this disclosure, a shunted plasma oscillation qubit, also known as a transmon qubit, can function as a capacitive quantum bit (charge qubit) in the superconducting quantum computing realm. This type of qubit is often referred to as a primary quantum bit under charge quantum bits (Cooper-pairbox). Its purpose is to increase the ratio between Josephson energy (EJ) and charge energy (EC) in order to flatten the dispersion relation of system energy states with respect to gate charge. To reduce sensitivity to charge noise, a large capacitor is connected in parallel at the two ends of a Josephson junction. Additionally, a coupling capacitor between the transmon qubit and a linear resonant cavity forms a circuit quantum electrodynamics (circuit-QED) system, which enables manipulation and readout of the quantum bits.

In the disclosed embodiments, the superconducting quantum chip may include the fluxonium-type qubits. The use of the fluxonium-type qubits can well suppress low-frequency charge drift while preserving high-frequency charge oscillation parts. When the flux in a fluxonium loop is changed, an energy level structure can be tuned over a wide range (0.5 GHz to 10 GHZ), thereby facilitating quick adjustment of the parameters of the quantum chip when the fidelity between two-qubit gates is low.

In some embodiments, the superconducting quantum chip may include the transmon-type qubits. By use of the transmon-type qubits, manipulation and readout of the quantum bits can be realized.

In an example of this disclosure, the influence of the environmental qubit gates associated with the two-qubit gate in the quantum processor on the two-qubit gate is considered. Based on the first target matrix and the first evolution matrix obtained after adding the environmental qubit gates, the fidelity of the two-qubit gate in a multi-qubit environment is determined, thereby improving the accuracy of measuring the fidelity of the two-qubit gate, achieving the technical effect of determining the fidelity of the two-qubit gate, and solving the technical problem of being unable to determine the fidelity of the two-qubit gate.

FIG. 5 is a flowchart of an example method for determining fidelity of a qubit gate in a quantum processor according to some embodiments of this disclosure, which may be applied to a software-as-a-service (SaaS) side. As shown in FIG. 5, the method may include the following steps S502-S508.

Step S502: Acquiring environmental qubit gates associated with a two-qubit gate in a quantum chip by invoking a first interface, where the first interface includes a first parameter, the parameter value of the first parameter involves the two-qubit gate and the environmental qubit gates, and the two-qubit gate interacts with the environmental qubit gates in the quantum chip.

In step S502 of this disclosure, the first interface may be an interface for data interaction between a server and a user side. The user side can invoke the first interface to obtain the environmental qubit gates associated with the two-qubit gate in the quantum chip. The interaction between the two-qubit gate and the environmental qubit gates in the quantum chip serves as the first parameter of the first interface, thereby achieving the purpose of obtaining the environmental qubit gates associated with the two-qubit gate in the quantum chip.

Step S504: Determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution.

Step S506: Determining the fidelity of the two-qubit gate based on the number of the environmental qubit gates, the first target matrix, and the first evolution matrix.

Step S508: Outputting the fidelity of the two-qubit gate by invoking a second interface, where the second interface includes a second parameter, and the parameter value of the second parameter represents the fidelity of the two-qubit gate.

In step S508 of this disclosure, the second interface may be an interface for data interaction between the server and the user side. The server can distribute the fidelity of the two-qubit gate to a client, enabling the client to output the fidelity of the two-qubit gate to the second interface as a parameter of the second interface, thereby achieving the purpose of distributing the fidelity of the two-qubit gate to the user side.

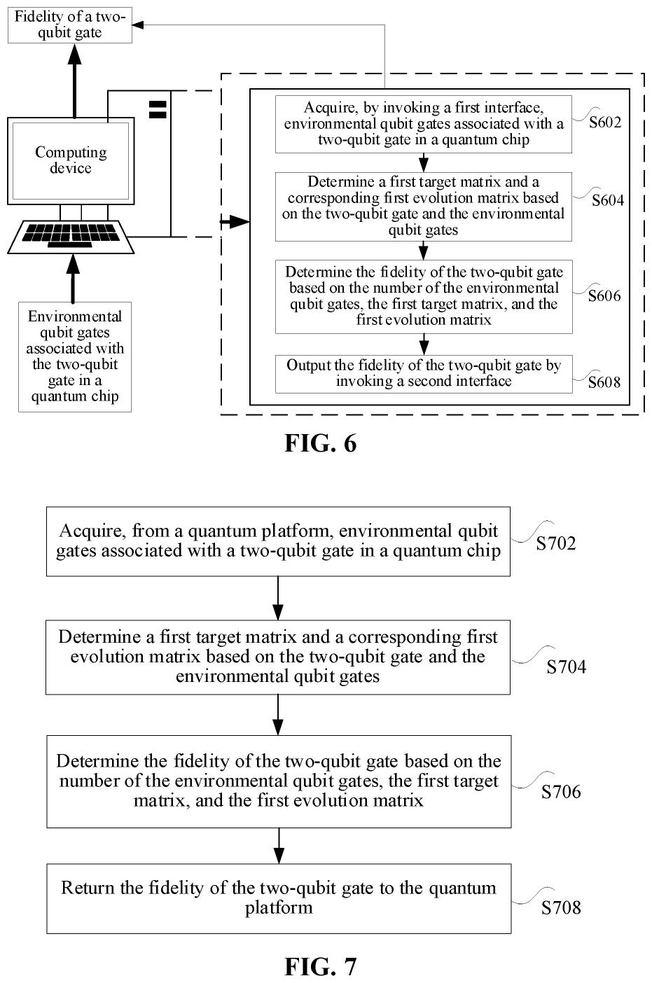

FIG. 6 is a schematic diagram illustrating a computer device accessing a private network according to some embodiments of this disclosure. As shown in FIG. 6, environmental qubit gates associated with a two-qubit gate in a quantum chip can be acquired by invoking a first interface, and the computer device performs steps S602-S608.

In step S602, the computer device acquires, by invoking a first interface, environmental qubit gates associated with a two-qubit gate in a quantum chip.

In step S604, the computer device determines a first target matrix and a corresponding first evolution matrix based on the two-qubit gate and the environmental qubit gates.

In step S606, the computer device determines the fidelity of the two-qubit gate based on the number of the environmental qubit gates, the first target matrix, and the first evolution matrix.

In step S608, the computer device outputs the fidelity of the two-qubit gate by invoking a second interface.

In some embodiments, a platform can output the fidelity of the two-qubit gate by invoking the second interface, where the second interface can be used for distributing the fidelity of the two-qubit gate to a client, such that the client sends the fidelity of the two-qubit gate.

FIG. 7 is a flowchart of an example method for determining fidelity of a qubit gate in a quantum processor according to some embodiments of this disclosure. As shown in FIG. 7, the method may include the following steps S702 to S708.

In step S702, a system (e.g., computer terminal 100 in FIG. 1) may acquire, from a quantum platform, environmental qubit gates associated with a two-qubit gate in a quantum chip, where the two-qubit gate interacts with the environmental qubit gates in the quantum chip.

In step S704, the system may determine a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution.

In step S706, the system may determine the fidelity of the two-qubit gate based on the number of the environmental qubit gates, the first target matrix, and the first evolution matrix.

In step S708, the system may return the fidelity of the two-qubit gate to the quantum platform.

According to the above steps S702 to S708 of this disclosure, the environmental qubit gates associated with the two-qubit gate in the quantum chip are obtained from the quantum platform, where the two-qubit gate interacts with the environmental qubit gates in the quantum chip; the first target matrix and the corresponding first evolution matrix are determined based on the two-qubit gate and the environmental qubit gates, where the first target matrix is the diagonal matrix represented based on the logic gate, and the first evolution matrix is the matrix obtained after time-dependent evolution; the fidelity of the two-qubit gate is determined based on the number of the environmental qubit gates, the first target matrix, and the first evolution matrix; and the fidelity of the two-qubit gate is returned to the quantum platform, thereby achieving the technical effect of determining the fidelity of the two-qubit gate, and solving the technical problem of being unable to determine the fidelity of the two-qubit gate.

In the conventional design process of superconducting quantum chips, only the fidelity of an isolated two-bit gate (quantum gate) is considered. However, in a real quantum chip, the two-bit gate inevitably interacts with surrounding quantum bits. But, there is no existing technology available to characterize the fidelity of the two-qubit gate in a multi-bit environment.

In addition, considering the influence on the two-qubit gate from environmental bits surrounding the two-qubit gate, a time evolution process of a multi-bit system is usually required to be solved. But, accurately solving the time evolution of the multi-qubit system is a changeling problem.

In order to characterize the fidelity of the two-qubit gate in a multi-bit environment, an example of this disclosure provides an example method for efficiently analyzing fidelity of a two-bit gate in a multi-bit superconducting quantum chip. To accurately solve the time evolution of the multi-bit system, a computational method for time evolution of a multi-bit system based on Trotter-Suzuki decomposition is developed.

The computational method for time evolution of a multi-bit system on Trotter-Suzuki decomposition in an example of this disclosure is further introduced below.

In the conventional technologies, fidelity of a two-qubit gate may be defined as:

$${F}_{ave} ( U , {U}_{target} ) = \frac{Tr ( {U}^{†} U ) + {\vert Tr ( {U}_{target}^{†} U ) \vert}^{2}}{20}$$

where, Fave can be used for representing the fidelity of the two-qubit gate, U can represent a second evolution matrix (matrix after time-dependent evolution), and U_{target} can represent a second target matrix (abbreviated as a target matrix). Tr can be used for representing the trace operation, and U⁺ can be used for representing a conjugate transpose matrix of the second evolution matrix; and U_{target}⁺ can be used for representing the conjugate transpose of the second target matrix.

In the disclosed embodiments, considering the influence of environmental qubit gates on the two-qubit gate, the second target matrix can be adjusted based on the environmental qubit gates to obtain the first target matrix, and the second evolution matrix can be adjusted based on the environmental qubit gates to obtain the first evolution matrix.

For example, the first target matrix can be obtained by adding the two environmental qubit gates to the two-qubit gate. Considering that the influence of the environmental qubit gates on the two-qubit gate varies over time, after time-delayed evolution is performed on the two-qubit gate, processing is performed based on the environmental qubit gates and a matrix obtained after time-delayed evolution, and the first evolution matrix can be obtained. Taking the two-qubit gate (iswap gate) as an example, the first target matrix can be used for representing the matrix obtained when the two-qubit gate is not affected by the surrounding environmental qubit gates, which can be:

$${U}_{t} = ( \begin{matrix}1 & 0 \\ 0 & {e}^{i {θ}_{2}}\end{matrix} ) ⊗ ( \begin{matrix}1 & 0 \\ 0 & {e}^{i {θ}_{2}}\end{matrix} ) ⊗ iSwap = ( \begin{matrix}iSwap & 0 & 0 & 0 \\ 0 & {e}^{i {θ}_{2}} iSwap & 0 & 0 \\ 0 & 0 & {e}^{i {θ}_{2}} iSwap & 0 \\ 0 & 0 & 0 & {e}^{i {θ}_{2} + i {θ}_{2}} iSwap\end{matrix} )$$

where, iSwap can be used for representing a logic gate, and characterizing interchanging of the states of two qubits in the two-qubit gate; i is an imaginary unit; and

$$( \begin{matrix}1 & 0 \\ 0 & {e}^{i {θ}_{2}}\end{matrix} ) and ( \begin{matrix}1 & 0 \\ 0 & {e}^{i {θ}_{2}}\end{matrix} )$$

may be evolution matrices obtained when the environmental qubit gates undergo isolated evolution.

In some embodiments, it can be assumed that the second evolution matrix is:

$${U}_{0} = ( \begin{matrix}{U}_{0}^{11} & {U}_{0}^{12} & {U}_{0}^{13} & {U}_{0}^{14} \\ {U}_{0}^{21} & {U}_{0}^{22} & {U}_{0}^{23} & {U}_{0}^{24} \\ {U}_{0}^{31} & {U}_{0}^{32} & {U}_{0}^{33} & {U}_{0}^{34} \\ {U}_{0}^{41} & {U}_{0}^{42} & {U}_{0}^{43} & {U}_{0}^{44}\end{matrix} )$$

In the disclosed embodiments, due to the inevitable interaction between the two-qubit gate and the surrounding environmental quantum bits, the second evolution matrix can be rotated based on the environmental qubit gates to obtain the first evolution matrix.

For example, optimized parameters (θ₁, θ₂, θ₃, θ₄) are added after rotation of two environmental qubits (abbreviated as single bits),

$${U}_{r} = {R}_{4}^{l} ( {θ}_{1} , {θ}_{2} ) {U}_{0} {R}_{4}^{r} ( {θ}_{3} , {θ}_{4} ) = ( \begin{matrix}{U}_{r}^{11} & {U}_{r}^{12} & {U}_{r}^{13} & {U}_{r}^{14} \\ {U}_{r}^{21} & {U}_{r}^{22} & {U}_{r}^{23} & {U}_{r}^{24} \\ {U}_{r}^{31} & {U}_{r}^{32} & {U}_{r}^{33} & {U}_{r}^{34} \\ {U}_{r}^{41} & {U}_{r}^{42} & {U}_{r}^{43} & {U}_{r}^{44}\end{matrix} )$$

where, R₄¹(θ₁, θ₂) can be used for representing a single-bit evolution matrix assuming that the environmental bits remain unchanged before time evolution of a real system; and R₄^{r}(θ₃, θ₄) can be used for representing a single-bit evolution matrix assuming that the environmental bits remain unchanged after time evolution of the real system.

In some embodiments, R₄¹(θ₁, θ₂) and R₄^{r}(θ₃, θ₄) can be determined based on following formula:

$${R}_{4}^{l} ( {θ}_{1} , {θ}_{2} ) = I ⊗ I ⊗ {R}^{t} ( {θ}_{1} , {θ}_{2} ) = ( \begin{matrix}{R}^{l} & 0 & 0 & 0 \\ 0 & {R}^{l} & 0 & 0 \\ 0 & 0 & {R}^{l} & 0 \\ 0 & 0 & 0 & {R}^{l}\end{matrix} )$$

$${R}_{4}^{r} ( {θ}_{3} , {θ}_{4} ) = I ⊗ I ⊗ {R}^{r} ( {θ}_{3} , {θ}_{4} ) = ( \begin{matrix}{R}^{r} & 0 & 0 & 0 \\ 0 & {R}^{r} & 0 & 0 \\ 0 & 0 & {R}^{r} & 0 \\ 0 & 0 & 0 & {R}^{r}\end{matrix} )$$

where, R^{l}(θ₁, θ₂) can be used for characterizing a single-bit evolution matrix assuming that the environmental bits remain unchanged before time evolution of the real system; R^{r}(θ₃, θ₄) can be used for characterizing a single-bit evolution matrix assuming that the environmental bits remain unchanged after time evolution of the real system; R^{l} can be used for characterizing a single-bit evolution matrix without considering the environmental bits before time evolution of the real system; R^{r} can be used for characterizing a single-bit evolution matrix without considering the environmental bits before time evolution of the real system; and θ₁ and θ₂ may be any preset unrelated independent parameters.

In some embodiments, the fidelity of the two-qubit gate can be determined based on the following formula:

$${F}_{ave} ( {U}_{r} , {U}_{t} ) = \frac{Tr ( {U}_{r}^{†} {U}_{r} ) + {\vert Tr ( {U}_{t}^{†} {U}_{r} ) \vert}^{2}}{n ( n + 1 )}$$

where, Fave (Uᵣ, Uₜ) can be used for representing the fidelity of the two-qubit gate determined based on the first target matrix and the first evolution matrix; Tr can be used for representing the trace operation, and Uᵣ⁺ can be used for representing conjugate transpose of the first evolution matrix; Uₜ⁺ can be used for representing conjugate transpose of the first target matrix; n may represent the number of the environmental qubit gates; and n+1 may represent an adjacent integer of the number of the environmental qubit gates.

The following further describe how to compute the fidelity of the two-qubit gate by taking the 4 environmental qubit gates as an example.

In some embodiments, due to Tr(AB)=Tr(BA), Tr(Uᵣ^{†}Uᵣ)=Tr(U₀^{†}U₀). A first term in a fidelity computing formula is a constant, and a second term can be optimized only by rotating the matrix. According to a matrix block operation rule:

$$Tr ( {U}_{i}^{†} {U}_{r} ) = Tr ( \begin{matrix}{iSwap}^{†} {U}_{r}^{11} & {iSwap}^{†} {U}_{r}^{12} & {iSwap}^{†} {U}_{r}^{13} & {iSwap}^{†} {U}_{r}^{14} \\ {e}^{- i {θ}_{s}} {iSwap}^{†} {U}_{r}^{21} & {e}^{- i {θ}_{2}} {iSwap}^{†} {U}_{r}^{22} & {e}^{- i {θ}_{2}} {iSwap}^{†} {U}_{r}^{23} & {e}^{- i {θ}_{2}} {iSwap}^{†} {U}_{r}^{24} \\ {e}^{- i {θ}_{s}} {iSwap}^{†} {U}_{r}^{31} & {e}^{- i {θ}_{2}} {iSwap}^{†} {U}_{r}^{32} & {e}^{- i {θ}_{2}} {iSwap}^{†} {U}_{r}^{33} & {e}^{- i {θ}_{2}} {iSwap}^{†} {U}_{r}^{34} \\ \begin{matrix}{e}^{- i {θ}_{1} - i {θ}_{2}} \\ {iSwap}^{†} {U}_{r}^{41}\end{matrix} & \begin{matrix}{e}^{- i {θ}_{1} - i {θ}_{2}} \\ {iSwap}^{†} {U}_{r}^{42}\end{matrix} & \begin{matrix}{e}^{- i {θ}_{1} - i {θ}_{2}} \\ {iSwap}^{†} {U}_{r}^{43}\end{matrix} & \begin{matrix}{e}^{- i {θ}_{1} - i {θ}_{2}} \\ {iSwap}^{†} {U}_{r}^{44}\end{matrix}\end{matrix} ) = Tr ( {iSwap}^{†} ( {U}_{r}^{11} + {c}^{- i {θ}_{2}} {U}_{r}^{22} + {c}^{- i {θ}_{1}} {U}_{r}^{33} + {c}^{- i {θ}_{1} - i {θ}_{2}} {U}_{r}^{44} ) )$$

Due to the following:

$${R}_{4}^{l} ( {θ}_{1} , {θ}_{2} ) = I ⊗ I ⊗ {R}^{l} ( {θ}_{1} , {θ}_{2} ) = ( \begin{matrix}{R}^{l} & 0 & 0 & 0 \\ 0 & {R}^{l} & 0 & 0 \\ 0 & 0 & {R}^{l} & 0 \\ 0 & 0 & 0 & {R}^{l}\end{matrix} )$$

$${R}_{4}^{r} ( {θ}_{3} , {θ}_{4} ) = I ⊗ I ⊗ {R}^{r} ( {θ}_{3} , {θ}_{4} ) = ( \begin{matrix}{R}^{r} & 0 & 0 & 0 \\ 0 & {R}^{r} & 0 & 0 \\ 0 & 0 & {R}^{r} & 0 \\ 0 & 0 & 0 & {R}^{r}\end{matrix} )$$

it can be determined that:

Tr(iSwap^{†}(Uᵣ¹¹+e^{-iθ}^{₂}Uᵣ²²+e^{-iθ}^{₁}Uᵣ³³+e^{-iθ}₁^{-iθ}^{₂}Uᵣ⁴⁴))=Tr(iSwap^{†}R^{l}(U₀₀¹¹+e^{-iθ}^{₂}U₀²²+e^{-iθ}₁U₀³³+e^{-iθ}^{₁}^{-iθ}^{₂}U₀⁴⁴)R^{r})

In an example of this disclosure, when there are only 4 environmental quantum bits, the problem of 4 quantum bits can be transformed into the problem of 2 quantum bits by simply multiplying four 4×4 block matrices on the diagonal line of the second evolution matrix by an environmental phase and then performing simple adding. The θ value corresponding to the highest fidelity can be found through variable θ₁, θ₂, θ₃, and θ₄. This method can be easily generalized to cases with any number of environmental bits.

In some embodiments, in a real superconducting quantum computing chip, a gate operation is implemented through the time evolution of a corresponding superconducting quantum system. In an example of this disclosure, high-efficiency simulation of the time evolution process of the superconducting quantum system is achieved by accurately determining the time-dependent Hamiltonian.

In an example of this disclosure, a computational method for time evolution of a multi-bit system based on Trotter-Suzuki decomposition is proposed for accurately solving the time evolution of the multi-qubit system. This method allows the deterministic compiler to decompose the computation of the time evolution. The compiler can process parameters such as the time-dependent Hamiltonian, each sub-evolution duration, the number of sub-evolution durations, the initial state (|ψ₀ [symbol] ) of the two-qubit gate, and the order of the compiler, thereby obtaining the final state (|ψ(t) [symbol] ) of the quantum chip after evolving from the initial state for the evolution duration. Based on the obtained mode, the time evolution of the multi-qubit system is accurately determined, thereby achieving the technical effect of determining the fidelity of the two-qubit gate, and solving the technical problem of being unable to determine the fidelity of the two-qubit gate.

In the disclosed embodiments, a quantum system in the initial state evolves for a time t and reaches the final state:

|ψ(t) [symbol] =U(t,0)|ψ₀

[symbol]

where, U(t,0) can be used for characterizing the time-dependent Hamiltonian corresponding to a sub-evolution duration t.

In some embodiments, the evolution time t can be divided into smaller segments, satisfying:

U(t₁,t₀)=U(t₁,t₁−τ) . . . U(t₀+2τ,t₀+τ)U(t₀+τ,t₀)

where, τ can be used for representing a time interval.

In some embodiments, when τ><1 is satisfied, the approximate value of the time-dependent Hamiltonian can be determined based on the following formula:

$$U ( {t}_{0} + τ , {t}_{0} ) = exp ( - i τ H ( {t}_{0} + \frac{τ}{2} ) )$$

where, exp is used for representing an exponential function; and H( ) can be used for representing a Hamiltonian function.

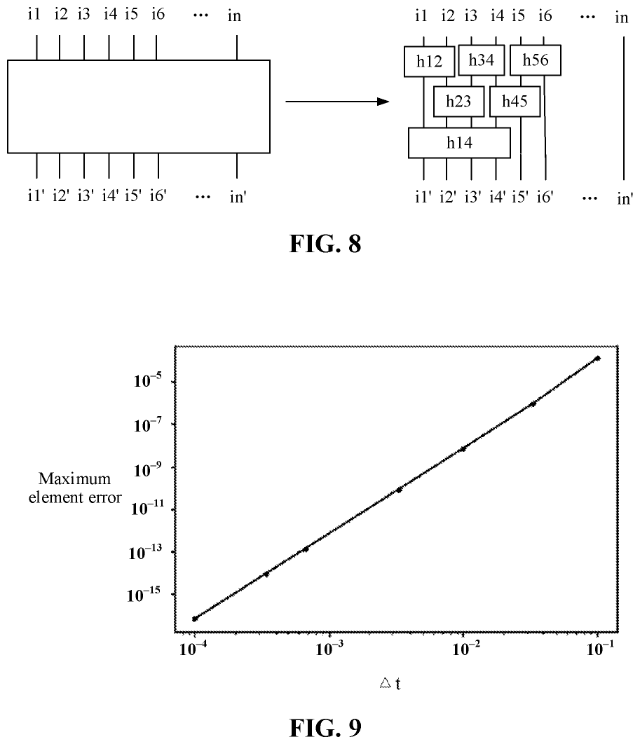

In some embodiments, FIG. 8 is a schematic diagram of a decomposition result according to some embodiments of this disclosure. As shown in FIG. 8, the evolution of a total space (H) may be decomposed into a series of two-qubit evolutions (h12, h14, h23, etc.), thereby greatly reducing the dimensionality of the evolution matrix.

In some embodiments, any Hamiltonian (H) can be written as a sum

$$( H = {\sum }_{ij} {h}_{ij} )$$

of a series of interactions of the two-qubit gate, and the deterministic compiler (Trotter-Suzuki) can perform decomposition through a following formula to obtain the time-dependent Hamiltonian:

$$U ( {t}_{0} + τ , {t}_{0} ) = exp ( - i τ H ( {t}_{0} + \frac{τ}{2} ) ) \approx {\prod }_{ij} exp ( - i τ {h}_{ij} ( {t}_{0} + \frac{τ}{2} ) )$$

In an example of this disclosure, the time evolution is decomposed and computed (e.g., trotter decomposition). By inputting parameters such as the Hamiltonian, the time intervals, the number of the time intervals (total time/time intervals), the initial state, the number of bit states, and the trotter order into a program, the program can accurately output the final state after evolution, thereby achieving the purpose of accurately solving the time evolution of the multi-bit system, further realizing the technical effect of determining the fidelity of the two-qubit gate, and solving the technical problem of being unable to determine the fidelity of the two-qubit gate.

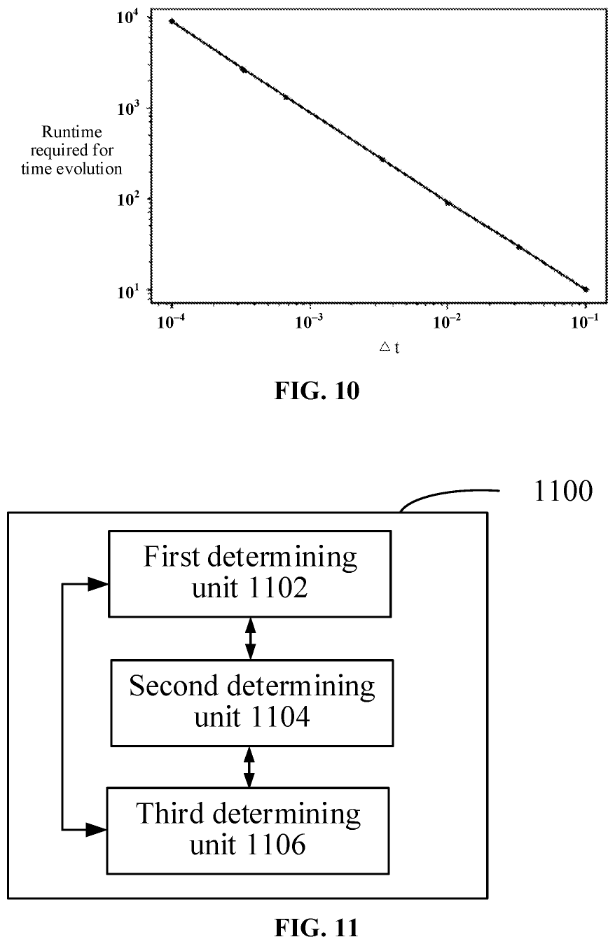

Taking constructing a logic gate (iswap) using two data qubit gates and two environmental qubit gates as an example, the gate operation duration remains unchanged. FIG. 9 is a schematic diagram of determining a fidelity error according to some embodiments of this disclosure. The accuracy of a 2^{nd}-order Trotter program is shown in FIG. 9, where the horizontal axis represents the time interval, and the vertical axis represents the maximum element error of the evolution matrix (max(ΔU)), which can be observed that the error is O(Δt⁴). FIG. 10 is a schematic diagram of determining time complexity for fidelity according to some embodiments of this disclosure. The time complexity of the 2^{nd}-order Trotter program is shown in FIG. 10, where the horizontal axis represents the time interval (Δt), and the vertical axis represents the runtime (T) required for time evolution, which can be observed that the time complexity is O(Δt⁻¹). Based on the above, the relationship between the runtime and the number n of bits in an example of this disclosure is O(d⁽ⁿ⁺²⁾), indicating that this disclosure has a significant advantage over a conventional method with the complexity of O(d²ⁿ). Therefore, the method of an example of this disclosure cannot only accurately determine the fidelity of the two-qubit gate, but also improve the processing efficiency of determining the fidelity of the two-qubit gate.

It is to be noted that, to simplify the description, the foregoing method examples are described as a series of action combinations. But it is appreciated that this disclosure is not limited to any described sequence of actions, as some steps can be executed in other sequences or executed at the same time according to this disclosure. In addition, those it is appreciated that all the examples described in the specification are preferred examples, and the related actions and modules are not necessary to this disclosure.

According to the descriptions in the foregoing implementations, it is appreciated that the method according to the above examples may be implemented by software and necessary universal hardware platforms and may also be implemented by hardware, but the former is a preferred implementation in many cases. Based on such an understanding, the technical solutions of this disclosure essentially, or the part contributing to the prior art may be presented in the form of a software product. The computer software product is stored in a storage medium (e.g., an ROM/RAM, a magnetic disk, and an optical disc), and includes several instructions to enable a terminal device (e.g., a mobile phone, a computer, a server, or a network device) to perform the methods described in the examples of this disclosure.

FIG. 11 is a schematic diagram of an example apparatus for determining fidelity of a qubit gate in a quantum chip according to some embodiments of this disclosure. As shown in FIG. 11, the apparatus 1100 for determining the fidelity of the qubit gate in the quantum chip may include: a first determining unit 1102, a second determining unit 1104, and a third determining unit 1106.

The first determining unit 1102 is configured to determine environmental qubit gates associated with a two-qubit gate in the quantum chip, where the two-qubit gate interacts with the environmental qubit gates in the quantum chip.

The second determining unit 1104 is configured to determine a first target matrix and a corresponding first evolution matrix based on the two-qubit gate and the environmental qubit gates, where the first target matrix is a diagonal matrix constructed based on a logic gate, and the first evolution matrix is a matrix obtained after time-dependent evolution.

The third determining unit 1106 is configured to determine the fidelity of the two-qubit gate based on the number of the environmental qubit gates, the first target matrix, and the first evolution matrix.

Here, it is to be noted that, the first determining unit 1102, the second determining unit 1104, and the third determining unit 1106 above each corresponds to steps S402 to S406 respectively, as described above. The examples and application scenarios implemented by the three units and the corresponding steps are the same, but are not limited to the content disclosed in these embodiments. It is to be noted that, the above units may be hardware components or software components stored in a memory (e.g., a memory 104) and processed by one or more processors (e.g., processors 102a, 102b, . . . , and 102n). The above units may also be a part of the apparatus to be run on the computer terminal 100 provided in some embodiments of this disclosure.

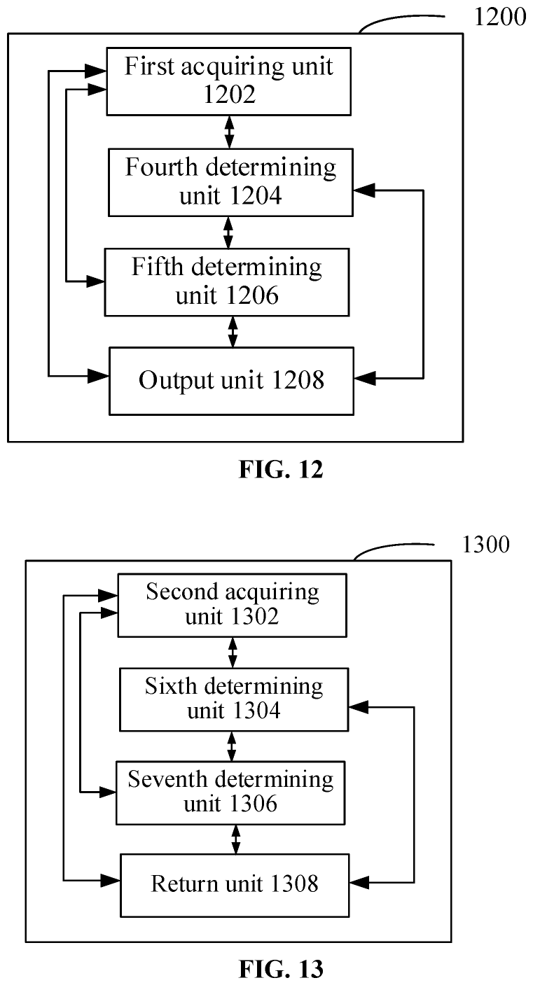

FIG. 12 is a schematic diagram of an apparatus for determining fidelity of a qubit gate in a quantum chip according to some embodiments of this disclosure. As shown in FIG. 12, the apparatus 1200 for determining the fidelity of the qubit gate in the quantum chip may include: a first acquiring unit 1202, a fourth determining unit 1204, a fifth determining unit 1206, and an output unit 1208.

The first acquiring unit 1202 is configured to acquire environmental qubit gates associated with a two-qubit gate in the quantum chip by invoking a first interface, where the first interface includes a first parameter, the parameter value of the first parameter involves the two-qubit gate and the environmental qubit gates, and the two-qubit gate interacts with the environmental qubit gates in the quantum chip.

The fourth determining unit 1204 is configured to determine a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution.

The fifth determining unit 1206 is configured to determine the fidelity of the two-qubit gate based on the number of the environmental qubit gates, the first target matrix, and the first evolution matrix.

The output unit 1208 is configured to output the fidelity of the two-qubit gate by invoking a second interface, where the second interface includes a second parameter, and the parameter value of the second parameter represents the fidelity of the two-qubit gate.

Here, it is to be noted that, the first acquiring unit 1202, the fourth determining unit 1204, the fifth determining unit 1206, and the output unit 1208 above each corresponds to steps S502 to S508 as mentioned above, respectively. The examples and application scenarios implemented by the four units and the corresponding steps are the same, but are not limited to the content disclosed in these embodiments. It is to be noted that, the above units may be hardware components or software components stored in a memory (e.g., a memory 104) and processed by one or more processors (e.g., processors 102a, 102b, . . . , and 102n). The above units may also be a part of the apparatus to be run on the computer terminal 100 provided in some embodiments of this disclosure.

FIG. 13 is a schematic diagram of an apparatus for determining fidelity of a qubit gate in a quantum chip according to some embodiments of this disclosure. As shown in FIG. 13, the apparatus 1300 for determining the fidelity of the qubit gate in the quantum chip may include: a second acquiring unit 1302, a sixth determining unit 1304, a seventh determining unit 1306, and a return unit 1308.

The second acquiring unit 1302 is configured to acquire, from a quantum platform, environmental qubit gates associated with a two-qubit gate in a quantum chip, where the two-qubit gate interacts with the environmental qubit gates in the quantum chip.

The sixth determining unit 1304 is configured to determine, based on the two-qubit gate and the environmental qubit gates, a first target matrix and a corresponding first evolution matrix, where the first target matrix is a diagonal matrix represented based on a logic gate, and the first evolution matrix is a matrix obtained after time-dependent evolution.

The seventh determining unit 1306 is configured to determine the fidelity of the two-qubit gate based on the number of the environmental qubit gates, the first target matrix, and the first evolution matrix.

The return unit 1308 is configured to return the fidelity of the two-qubit gate to the quantum platform.

Here, it is to be noted that, the second acquiring unit 1302, the sixth determining unit 1304, the seventh determining unit 1306, and the return unit 1308 above each corresponds to steps S702 to S708 described above, respectively. The examples and application scenarios implemented by the four units and the corresponding steps are the same, but are not limited to the content disclosed in the these embodiments. It is to be noted that, the above units may be hardware components or software components stored in a memory (e.g., a memory 104) and processed by one or more processors (e.g., processors 102a, 102b, . . . , and 102n). The above units may also be a part of the apparatus to be run on the computer terminal 100 provided in some embodiments of this disclosure.

According to the apparatus for determining the fidelity of the qubit gate in the quantum chip in the disclosed embodiments, the influence of the environmental qubit gates associated with the two-qubit gate in the quantum processor on the two-qubit gate is considered. Based on the first target matrix and the first evolution matrix obtained after adding the environmental qubit gates, the fidelity of the two-qubit gate in a multi-qubit environment is determined, thereby improving the accuracy of measuring the fidelity of the two-qubit gate, achieving the technical effect of determining the fidelity of the two-qubit gate, and solving the technical problem of being unable to determine the fidelity of the two-qubit gate.

An example of this disclosure may provide a computer terminal. The computer terminal may be any computer terminal device in a computer terminal cluster. In some embodiments, the above computer terminal may be replaced with terminal devices such as a mobile terminal.

In some embodiments, the above computer terminal may be located in at least one of a plurality of network devices in a computer network.

In the disclosed embodiments, the above computer terminal may execute program code in an application for performing the following steps of the method for determining fidelity of a qubit gate in a quantum chip: environmental qubit gates associated with a two-qubit gate in the quantum chip are determined, where the two-qubit gate interacts with the environmental qubit gates in the quantum chip; based on the two-qubit gate and the environmental qubit gates, a first target matrix and a corresponding first evolution matrix are determined, where the first target matrix is a diagonal matrix constructed based on a logic gate, and the first evolution matrix is a matrix obtained after time-dependent evolution; and the fidelity of the two-qubit gate is determined based on the number of the environmental qubit gates, the first target matrix, and the first evolution matrix.

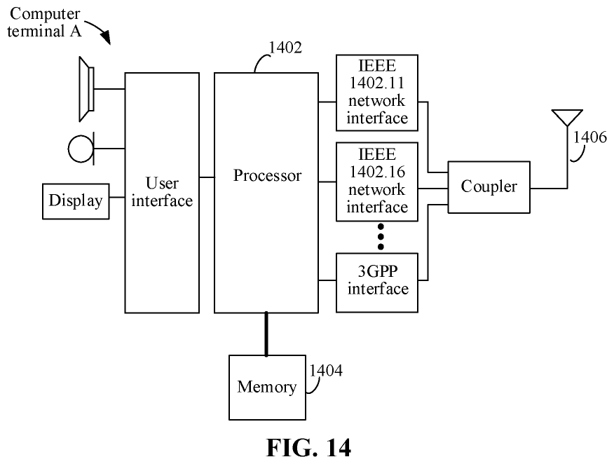

In some embodiments, FIG. 14 is a structural block diagram of a computer terminal according to some embodiments of this disclosure. As shown in FIG. 14, the computer terminal A may include: one or more processors 1402 (only one is shown in the figure), a memory 1404, and a transmission apparatus 1406.

The memory may be configured to store software programs and modules, such as program instructions/modules corresponding to the method and apparatus for determining fidelity of a qubit gate in a quantum chip in an example of this disclosure. The processor performs, by running the software programs and the modules stored in the memory, various functional applications and predictions, thereby implementing the above method for determining fidelity of a qubit gate in a quantum chip. The memory may include a high-speed random memory, and may also include a non-volatile memory, such as one or more magnetic storage apparatuses, a flash memory, or other nonvolatile solid-state memories. In the disclosed embodiments, the memory may further include memories remotely disposed relative to the processor, and these remote memories may be connected to the computer terminal A through networks. The examples of the above networks include but not limited to an Internet, an intranet, a local area network, a mobile communication network and a combination thereof.

The processor may perform the following steps by invoking, through the transmission apparatus, the information and disclosure programs stored in the memory: determining environmental qubit gates associated with a two-qubit gate in the quantum chip, where the two-qubit gate interacts with the environmental qubit gates in the quantum chip; determining a first target matrix and a corresponding first evolution matrix based on the two-qubit gate and the environmental qubit gates, where the first target matrix is a diagonal matrix constructed based on a logic gate, and the first evolution matrix is a matrix obtained after time-dependent evolution; and determining the fidelity of the two-qubit gate based on the number of the environmental qubit gates, the first target matrix, and the first evolution matrix.

In some embodiments, the above processor may further perform program code of the following steps: adjusting the second target matrix based on the environmental qubit gates to obtain the first target matrix; and adjusting the second evolution matrix based on the environmental qubit gates to obtain the first evolution matrix.

In some embodiments, the above processor may further perform program code of the following step: performing tensor processing on the second target matrix based on the environmental qubit gates to obtain the first target matrix.

In some embodiments, the above processor may further perform program code of the following step: rotating the second evolution matrix based on the environmental qubit gates to obtain the first evolution matrix.

In some embodiments, the above processor may further perform program code of the following steps: obtaining a first trace of a product between a conjugate transpose matrix of the first evolution matrix and the first evolution matrix; obtaining a second trace of a product between a conjugate transpose matrix of the first target matrix and the first evolution matrix; and determining the fidelity of the two-qubit gate based on the first trace and the square of the second trace, as well as the number of the environmental qubit gates.

In some embodiments, the above processor may further perform program code of the following step: determining the fidelity of the two-qubit gate based on the first trace and the square of the second trace, the number of the environmental qubit gates, and an adjacent integer of the number of the environmental qubit gates.

In some embodiments, the above processor may further perform program code of the following step: determining a third trace of a product between the conjugate transpose matrix of the second evolution matrix and the second evolution matrix as the first trace.

In some embodiments, the above processor may further perform program code of the following step: determining the second trace based on the sum of block matrices on a diagonal line of the second evolution matrix.

In some embodiments, the above processor may further perform program code of the following steps: determining an initial time for evolution and an evolution duration of the quantum chip; dividing the evolution duration into a plurality of equal sub-evolution durations; and determining the time-dependent Hamiltonian corresponding to each sub-evolution duration of the quantum chip based on the first evolution matrix, the initial time, and each sub-evolution duration.

In some embodiments, the above processor may further perform program code of the following step: determining the final state of the quantum chip after evolving from the initial state for an evolution duration at least based on the time-dependent Hamiltonian corresponding to each sub-evolution duration of the quantum chip, each sub-evolution duration, and the number of sub-evolution durations.

In some embodiments, the processor may perform the following steps by invoking, through the transmission apparatus, the information and application programs stored in the memory: acquiring environmental qubit gates associated with a two-qubit gate in a quantum chip by invoking a first interface, where the first interface includes a first parameter, the parameter value of the first parameter involves the two-qubit gate and the environmental qubit gates, and the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and outputting the fidelity of the two-qubit gate by invoking a second interface, where the second interface includes a second parameter, and the parameter value of the second parameter represents the fidelity of the two-qubit gate.

In some embodiments, the processor may perform the following steps by invoking, through the transmission apparatus, the information and application programs stored in the memory: obtaining environmental qubit gates associated with a two-qubit gate in a quantum chip from a quantum platform, where the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and returning the fidelity of the two-qubit gate to the quantum platform.

According to an example of this disclosure, the influence of the environmental qubit gates associated with the two-qubit gate in the quantum processor on the two-qubit gate is considered. Based on the first target matrix and the first evolution matrix obtained after adding the environmental qubit gates, the fidelity of the two-qubit gate in a multi-qubit environment is determined, thereby improving the accuracy of measuring the fidelity of the two-qubit gate, achieving the technical effect of determining the fidelity of the two-qubit gate, and solving the technical problem of being unable to determine the fidelity of the two-qubit gate.

It is appreciated that, the structure shown in FIG. 14 is only illustrative. The computer terminal A may also be a terminal device such as a smartphone (e.g., a tablet, a palmtop computer, and mobile Internet devices (MIDs)), and PAD. FIG. 14 does not limit the structure of the above computer terminal A. For example, the computer terminal A may further include more or fewer components (e.g., a network interface and a display apparatus) than those shown in FIG. 14, or has a configuration different from that shown in FIG. 14.

It is appreciated that all or some of steps of various methods in the above examples may be implemented by a program instructing related hardware of the terminal device. The program may be stored in a computer-readable storage medium. The storage medium may include: a flash drive, a read-only memory (ROM), a random access memory (RAM), a magnetic disk and an optical disc.

An example of this disclosure further provides a computer-readable storage medium. In some embodiments, the above computer-readable storage medium may be configured to store program code for performing the method for determining fidelity of a qubit gate in a quantum chip in some embodiments of this disclosure.

In some embodiments, the above computer-readable storage medium may be located in any computer terminal within a computer terminal cluster in a computer network or in any mobile terminal within a mobile terminal cluster.

In some embodiments, the above computer-readable storage medium may be set to store program code used for performing the following steps: determining environmental qubit gates associated with a two-qubit gate in the quantum chip, where the two-qubit gate interacts with the environmental qubit gates in the quantum chip; determining a first target matrix and a corresponding first evolution matrix based on the two-qubit gate and the environmental qubit gates, where the first target matrix is a diagonal matrix constructed based on a logic gate, and the first evolution matrix is a matrix obtained after time-dependent evolution; and determining the fidelity of the two-qubit gate based on the number of the environmental qubit gates, the first target matrix, and the first evolution matrix.

In some embodiments, the above computer-readable storage medium may further perform program code of the following steps: adjusting a second target matrix based on the environmental qubit gates to obtain the first target matrix; and adjusting a second evolution matrix based on the environmental qubit gates to obtain the first evolution matrix.

In some embodiments, the above computer-readable storage medium may further perform program code of the following step: performed tensor processing on the second target matrix based on the environmental qubit gates to obtain the first target matrix.

In some embodiments, the above computer-readable storage medium may further perform program code of the following step: rotating the second evolution matrix based on the environmental qubit gates to obtain the first evolution matrix.

In some embodiments, the above computer-readable storage medium may further perform program code of the following steps: obtaining a first trace of a product between a conjugate transpose matrix of the first evolution matrix and the first evolution matrix; obtaining a second trace of a product between a conjugate transpose matrix of the first target matrix and the first evolution matrix; and determining the fidelity of the two-qubit gate based on the first trace and the square of the second trace, as well as the number of the environmental qubit gates.

In some embodiments, the above computer-readable storage medium may further perform program code of the following step: determining the fidelity of the two-qubit gate based on the first trace and the square of the second trace, the number of the environmental qubit gates, and an adjacent integer of the number of the environmental qubit gates.

In some embodiments, the above computer-readable storage medium may further perform program code of the following step: determining a third trace of a product between the conjugate transpose matrix of the second evolution matrix and the second evolution matrix as the first trace.

In some embodiments, the above computer-readable storage medium may further perform program code of the following step: determining the second trace based on the sum of block matrices on a diagonal line of the second evolution matrix.

In some embodiments, the above computer-readable storage medium may further perform program code of the following steps: determining an initial time for evolution and an evolution duration of the quantum chip; dividing the evolution duration into a plurality of equal sub-evolution durations; and determining the time-dependent Hamiltonian corresponding to each sub-evolution duration of the quantum chip based on the first evolution matrix, the initial time, and each sub-evolution duration.

In some embodiments, the above computer-readable storage medium may further perform program code of the following step: determining the final state of the quantum chip after evolving from the initial state for an evolution duration at least based on the time-dependent Hamiltonian corresponding to each sub-evolution duration of the quantum chip, each sub-evolution duration, and the number of sub-evolution durations.

In some embodiments, the computer-readable storage medium is set to store program code used for performing the following steps: acquiring environmental qubit gates associated with a two-qubit gate in a quantum chip by invoking a first interface, where the first interface includes a first parameter, the parameter value of the first parameter involves the two-qubit gate and the environmental qubit gates, and the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and outputting the fidelity of the two-qubit gate by invoking a second interface, where the second interface includes a second parameter, and the parameter value of the second parameter represents the fidelity of the two-qubit gate.

In some embodiments, the computer-readable storage medium is set to store program code used for performing the following steps: obtaining environmental qubit gates associated with a two-qubit gate in a quantum chip from a quantum platform, where the two-qubit gate interacts with the environmental qubit gates in the quantum chip; determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution; determining the fidelity of the two-qubit gate based on the number of the environmental qubit gates, the first target matrix, and the first evolution matrix; and returning the fidelity of the two-qubit gate to the quantum platform.

The above sequence numbers of the examples of this disclosure are merely for the description purpose, but do not imply any superiority or inferiority of the examples.

In some embodiments of this disclosure, the examples are described with respective focuses. For a part that is not described in detail in an example, refer to related descriptions in other examples.

In some embodiments provided in this disclosure, it is to be understood that the disclosed technical content may be implemented in other manners. The above-described apparatus examples are merely illustrative, such as unit division which is merely logical function division, and during practical implementation, there may be additional division manners. For example, a plurality of units or assemblies may be combined or integrated into another system, or some characteristics may be ignored or not executed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and components displayed as units may or may not be physical units, that is, may be located in one position, or may be distributed on a plurality of network units. Some or all of the units may be selected according to actual needs to achieve the objectives of the solutions of the examples.

In addition, functional units in the examples of this disclosure may be integrated into a processing unit, or each of the units may be physically separated, or two or more units may be integrated into a unit. The above integrated unit may be implemented in the form of hardware or a software functional unit.

If the integrated unit is implemented in the form of the software functional unit and sold or used as an independent product, the integrated unit may be stored in a computer-readable storage medium. Based on such an understanding, the technical solutions of this disclosure essentially, or the part contributing to the prior art, or all or some of the technical solutions may be embodied in the form of a software product. The computer software product is stored in a storage medium and includes several instructions for instructing a computer device (e.g., a personal computer, a server, or a network device) to perform all or some of the steps of the methods described in the examples of this disclosure. The foregoing storage medium includes: a USB flash drive, a read-only memory (ROM), a random access memory (RAM), a portable hard disk drive, a magnetic disk, an optical disc, or various media that can store program code.

The embodiments may further be described using the following clauses:

1. A method for determining fidelity of a qubit gate in a quantum chip, including:

determining environmental qubit gates associated with a two-qubit gate in the quantum chip, wherein the two-qubit gate interacts with the environmental qubit gates in the quantum chip;

determining a first target matrix and a corresponding first evolution matrix, based on the two-qubit gate and the environmental qubit gates associated with the two-qubit gate, wherein the first target matrix is a diagonal matrix constructed based on a logic gate, and the first evolution matrix is a matrix obtained after time-dependent evolution; and

determining the fidelity of the two-qubit gate based on the number of the environmental qubit gates, the first target matrix, and the first evolution matrix.

2. The method according to clause 1, wherein when the two-qubit gate does not interact with the environmental qubit gates, the fidelity of the two-qubit gate is determined by a second target matrix and a second evolution matrix, the second target matrix is used for representing the logic gate, and the second evolution matrix includes a plurality of block matrices obtained after time-dependent evolution; and determining the first target matrix and the corresponding first evolution matrix includes:

adjusting the second target matrix based on the environmental qubit gates to obtain the first target matrix; and

adjusting the second evolution matrix based on the environmental qubit gates to obtain the first evolution matrix.

3. The method according to clause 2, wherein adjusting the second target matrix based on the environmental qubit gates to obtain the first target matrix includes:

performing tensor processing on the second target matrix based on the environmental qubit gates to obtain the first target matrix.

4. The method according to clause 2, wherein adjusting the second evolution matrix based on the environmental qubit gates to obtain the first evolution matrix includes:

rotating the second evolution matrix based on the environmental qubit gates to obtain the first evolution matrix.

5. The method according to clause 1, wherein determining the fidelity of the two-qubit gate based on the number of the environmental qubit gates associated with the two-qubit gate, the first target matrix, and the first evolution matrix includes:

obtaining a first trace of a product between a conjugate transpose matrix of the first evolution matrix and the first evolution matrix;

obtaining a second trace of a product between a conjugate transpose matrix of the first target matrix and the first evolution matrix; and

determining the fidelity of the two-qubit gate based on the first trace, a square of the second trace, and the number of the environmental qubit gates associated with the two-qubit gate.

6. The method according to clause 5, wherein determining the fidelity of the two-qubit gate based on the first trace, the square of the second trace, and the number of the environmental qubit gates associated with the two-qubit gate includes:

determining the fidelity of the two-qubit gate based on the first trace, the square of the second trace, the number of the environmental qubit gates, and an adjacent integer of the number of the environmental qubit gates.

7. The method according to clause 5, wherein when the two-qubit gate does not interact with the environmental qubit gates, the fidelity of the two-qubit gate is determined at least by a second evolution matrix, and obtaining a first trace of a product between a conjugate transpose matrix of the first evolution matrix and the first evolution matrix includes:

determining a third trace of a product between a conjugate transpose matrix of the second evolution matrix and the second evolution matrix as the first trace.

8. The method according to clause 7, wherein obtaining a second trace of a product between a conjugate transpose matrix of the first target matrix and the first evolution matrix includes:

determining the second trace based on the sum of block matrices on a diagonal line of the second evolution matrix.

9. The method according to clause 1, further including:

determining an initial time for evolution and an evolution duration of the quantum chip;

dividing the evolution duration into a plurality of equal sub-evolution durations; and

determining time-dependent Hamiltonian corresponding to each of the plurality of sub-evolution durations of the quantum chip based on the first evolution matrix, the initial time, and each of the plurality of sub-evolution durations.

10. The method according to clause 9, further including:

determining a final state of the quantum chip after evolving from an initial state for the evolution duration at least based on the time-dependent Hamiltonian corresponding to each of the plurality of sub-evolution durations of the quantum chip, each of the plurality of sub-evolution durations, and the number of the plurality of sub-evolution durations.

11. The method according to clause 1, wherein the quantum chip is a superconducting quantum chip.

12. The method according to clause 11, wherein the superconducting quantum chip includes fluxonium-type qubits, or transmon-type qubits.

13. A method for determining fidelity of a qubit gate in a quantum chip, including:

acquiring, by invoking a first interface, environmental qubit gates associated with a two-qubit gate in the quantum chip, wherein the first interface includes a first parameter having a first parameter corresponding to the two-qubit gate and the environmental qubit gates, wherein the two-qubit gate interacts with the environmental qubit gates in the quantum chip;

determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;

determining the fidelity of the two-qubit gate based on the number of the environmental qubit gates interacting with the two-qubit gate, the first target matrix, and the first evolution matrix; and

outputting the fidelity of the two-qubit gate by invoking a second interface, wherein the second interface includes a second parameter having a second parameter value representing the fidelity of the two-qubit gate.

14. A method for determining fidelity of a qubit gate in a quantum chip, including:

acquiring, from a quantum platform, environmental qubit gates associated with a two-qubit gate in the quantum chip, wherein the two-qubit gate interacts with the environmental qubit gates in the quantum chip;

determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;

determining the fidelity of the two-qubit gate based on the number of the environmental qubit gates associated with the two-qubit gage, the first target matrix, and the first evolution matrix; and

returning the fidelity of the two-qubit gate to the quantum platform.

15. A non-transitory computer-readable storage medium storing a set of instructions that are executable by one or more processors of a device to cause the device to perform operations for determining fidelity of a qubit gate in a quantum chip, the operations comprising:

determining environmental qubit gates associated with a two-qubit gate in the quantum chip, wherein the two-qubit gate interacts with the environmental qubit gates in the quantum chip;

determining a first target matrix and a corresponding first evolution matrix, based on the two-qubit gate and the environmental qubit gates, wherein the first target matrix is a diagonal matrix constructed based on a logic gate, and the first evolution matrix is a matrix obtained after time-dependent evolution; and

determining the fidelity of the two-qubit gate based on the number of the environmental qubit gates associated with the two-qubit gate, the first target matrix, and the first evolution matrix.

16. A method for determining fidelity of a qubit gate in a quantum processor, including:

acquiring, from a quantum platform, environmental qubit gates associated with a two-qubit gate in a quantum chip, where the two-qubit gate interacts with the environmental qubit gates in the quantum chip;

determining a first target matrix and a corresponding first evolution matrix based on the two-qubit gate and the environmental qubit gates, where the first target matrix is a diagonal matrix represented based on a logic gate, and the first evolution matrix is a matrix obtained after time-dependent evolution;

determining the fidelity of the two-qubit gate based on the number of the environmental qubit gates, the first target matrix, and the first evolution matrix; and

returning the fidelity of the two-qubit gate to the quantum platform.

17. An apparatus for determining fidelity of a qubit gate in a quantum processor, including:

a memory storing instructions; and

one or more processors configured to execute the instructions to cause the apparatus to perform operations comprising:
determining environmental qubit gates associated with a two-qubit gate in the quantum chip, wherein the two-qubit gate interacts with the environmental qubit gates in the quantum chip;
determining a first target matrix and a corresponding first evolution matrix, based on the two-qubit gate and the environmental qubit gates associated with the two-qubit gate, wherein the first target matrix is a diagonal matrix constructed based on a logic gate, and the first evolution matrix is a matrix obtained after time-dependent evolution; and
determining the fidelity of the two-qubit gate based on the number of the environmental qubit gates, the first target matrix, and the first evolution matrix.

18. An apparatus for determining fidelity of a qubit gate in a quantum processor, including:

a memory storing instructions; and

one or more processors configured to execute the instructions to cause the apparatus to perform operations comprising:
acquiring, by invoking a first interface, environmental qubit gates associated with a two-qubit gate in the quantum chip, wherein the first interface includes a first parameter having a first parameter corresponding to the two-qubit gate and the environmental qubit gates, wherein the two-qubit gate interacts with the environmental qubit gates in the quantum chip;
determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;
determining the fidelity of the two-qubit gate based on the number of the environmental qubit gates interacting with the two-qubit gate, the first target matrix, and the first evolution matrix; and
outputting the fidelity of the two-qubit gate by invoking a second interface, wherein the second interface includes a second parameter having a second parameter value representing the fidelity of the two-qubit gate.

19. An apparatus for determining fidelity of a qubit gate in a quantum processor, including:

a memory storing instructions; and

one or more processors configured to execute the instructions to cause the apparatus to perform operations comprising:
acquiring, from a quantum platform, environmental qubit gates associated with a two-qubit gate in the quantum chip, wherein the two-qubit gate interacts with the environmental qubit gates in the quantum chip;
determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;
determining the fidelity of the two-qubit gate based on the number of the environmental qubit gates associated with the two-qubit gage, the first target matrix, and the first evolution matrix; and
returning the fidelity of the two-qubit gate to the quantum platform.

20. A processor configured to run programs, wherein the programs, when run, execute any above method for determining fidelity of a qubit gate in a quantum processor.

It is to be noted that, the terms such as “first” and “second” in the specification and claims of this disclosure and the above accompanying drawings are used for distinguishing similar objects but not necessarily used for describing particular order or sequence. It is to be understood that such used data is interchangeable where appropriate so that the examples of this disclosure described here can be implemented in an order other than those illustrated or described here. Moreover, the terms “include”, “have” and any other variants thereof mean to cover the non-exclusive inclusion. For example, a process, method, system, product, or device that includes a list of steps or units is not necessarily limited to those expressly listed steps or units, but may include other steps or units not expressly listed or inherent to such a process, method, system, product, or device.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The foregoing descriptions are merely preferred implementations of this disclosure. It is to be noted that a plurality of improvements and refinements may be made by those of ordinary skill in the technical field without departing from the principle of this disclosure, and shall fall within the scope of protection of this disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for determining fidelity of a qubit gate in a quantum chip, comprising:
determining environmental qubit gates associated with a two-qubit gate in the quantum chip, wherein the two-qubit gate interacts with the environmental qubit gates in the quantum chip;
determining a first target matrix and a corresponding first evolution matrix, based on the two-qubit gate and the environmental qubit gates, wherein the first target matrix is a diagonal matrix constructed based on a logic gate, and the first evolution matrix is a matrix obtained after time-dependent evolution; and
determining the fidelity of the two-qubit gate based on the number of the environmental qubit gates associated with the two-qubit gate, the first target matrix, and the first evolution matrix.

2. The method according to claim 1, wherein when the two-qubit gate does not interact with the environmental qubit gates, the fidelity of the two-qubit gate is determined by a second target matrix and a second evolution matrix, the second target matrix is used for representing the logic gate, and the second evolution matrix comprises a plurality of block matrices obtained after time-dependent evolution; and determining the first target matrix and the corresponding first evolution matrix comprises:
adjusting the second target matrix based on the environmental qubit gates to obtain the first target matrix; and
adjusting the second evolution matrix based on the environmental qubit gates to obtain the first evolution matrix.

3. The method according to claim 2, wherein adjusting the second target matrix based on the environmental qubit gates to obtain the first target matrix comprises:
performing tensor processing on the second target matrix based on the environmental qubit gates to obtain the first target matrix.

4. The method according to claim 2, wherein adjusting the second evolution matrix based on the environmental qubit gates to obtain the first evolution matrix comprises:
rotating the second evolution matrix based on the environmental qubit gates to obtain the first evolution matrix.

5. The method according to claim 1, wherein determining the fidelity of the two-qubit gate based on the number of the environmental qubit gates associated with the two-qubit gate, the first target matrix, and the first evolution matrix comprises:
obtaining a first trace of a product between a conjugate transpose matrix of the first evolution matrix and the first evolution matrix;
obtaining a second trace of a product between a conjugate transpose matrix of the first target matrix and the first evolution matrix; and
determining the fidelity of the two-qubit gate based on the first trace, a square of the second trace, and the number of the environmental qubit gates associated with the two-qubit gate.

6. The method according to claim 5, wherein determining the fidelity of the two-qubit gate based on the first trace, the square of the second trace, and the number of the environmental qubit gates associated with the two-qubit gate comprises:
determining the fidelity of the two-qubit gate based on the first trace, the square of the second trace, the number of the environmental qubit gates, and an adjacent integer of the number of the environmental qubit gates.

7. The method according to claim 5, wherein when the two-qubit gate does not interact with the environmental qubit gates, the fidelity of the two-qubit gate is determined at least by a second evolution matrix, and obtaining a first trace of a product between a conjugate transpose matrix of the first evolution matrix and the first evolution matrix comprises:
determining a third trace of a product between a conjugate transpose matrix of the second evolution matrix and the second evolution matrix as the first trace.

8. The method according to claim 7, wherein obtaining a second trace of a product between a conjugate transpose matrix of the first target matrix and the first evolution matrix comprises:
determining the second trace based on the sum of block matrices on a diagonal line of the second evolution matrix.

9. The method according to claim 1, further comprising:
determining an initial time for evolution and an evolution duration of the quantum chip;
dividing the evolution duration into a plurality of equal sub-evolution durations; and
determining time-dependent Hamiltonian corresponding to each of the plurality of sub-evolution durations of the quantum chip based on the first evolution matrix, the initial time, and each of the plurality of sub-evolution durations.

10. The method according to claim 9, further comprising:
determining a final state of the quantum chip after evolving from an initial state for the evolution duration at least based on the time-dependent Hamiltonian corresponding to each of the plurality of sub-evolution durations of the quantum chip, each of the plurality of sub-evolution durations, and the number of the plurality of sub-evolution durations.

11. The method according to claim 1, wherein the quantum chip is a superconducting quantum chip.

12. The method according to claim 11, wherein the superconducting quantum chip comprises fluxonium-type qubits, or transmon-type qubits.

13. A method for determining fidelity of a qubit gate in a quantum chip, comprising:
acquiring, by invoking a first interface, environmental qubit gates associated with a two-qubit gate in the quantum chip, wherein the first interface comprises a first parameter having a first parameter value corresponding to the two-qubit gate and the environmental qubit gates, wherein the two-qubit gate interacts with the environmental qubit gates in the quantum chip;
determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;
determining the fidelity of the two-qubit gate based on the number of the environmental qubit gates interacting with the two-qubit gate, the first target matrix, and the first evolution matrix; and
outputting the fidelity of the two-qubit gate by invoking a second interface, wherein the second interface comprises a second parameter having a second parameter value representing the fidelity of the two-qubit gate.

14. A method for determining fidelity of a qubit gate in a quantum chip, comprising:
acquiring, from a quantum platform, environmental qubit gates associated with a two-qubit gate in the quantum chip, wherein the two-qubit gate interacts with the environmental qubit gates in the quantum chip;
determining a first target matrix and a corresponding first evolution matrix based on the two-qubit gate and the environmental qubit gates, wherein the first target matrix is a diagonal matrix represented based on a logic gate, and the first evolution matrix is a matrix obtained after time-dependent evolution;
determining the fidelity of the two-qubit gate based on the number of the environmental qubit gates associated with the two-qubit gage, the first target matrix, and the first evolution matrix; and
returning the fidelity of the two-qubit gate to the quantum platform.
